(19) United States
(12) Patent Application Publication
(10) Pub. No.: US 2010/0275598 A1
(43) Pub. Date: Nov. 4, 2010

(54) THERMAL AIR ENGINE

(76) Inventors: Peter Robert Raffaele, Tongala (AU); Michael John Raffaele, Tongala (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/531,953

(22) PCT Filed: Mar. 18, 2008
(86) PCT No.: PCT/AU08/00389

§ 371 Date: Mar. 19, 2010

(30) Foreign Application Priority Data
Mar. 18, 2007 (AU) 2007901469
Mar. 19, 2007 (AU) 2007901579

(51) Int. Cl. F03G 6/00; H02K 7/18

(52) U.S. Cl. 60/641.8; 290/1 R

(57) ABSTRACT

A thermal air engine for the production of electricity which uses collector exchanger means to transport heat into an updraft tract to impart heat into the air in the tract such that it rises in the tract causing a partial vacuum above a turbine means located below the exchanger means in the tract; the turbine means adapted to extract work from the air passing through it such that it drives a generating means for the production of electrical energy.

### FIELD OF INVENTION

This disclosure relates to solar thermal engines for the production of electricity by a turbine driven electrical current generating machine placed in the flow path of the air column of an elongate and hollow gas flow tract.

### THE PRIOR ART

It is known to use solar thermal radiation to heat a body of air trapped beneath a roof structure to drive a turbine in a exhaust stack associated with the roof structure to produce electrical energy by the driving of the turbine means. The known solar thermal uplift tower includes a roof structure which allows the suns rays to pass through the surface of the roof to strike the ground and matter resting thereupon such the ground and matter is heated by the suns rays and also that the air beneath the roof is heated as the rays pass through it. The roof includes at least one tower or chimney like stack which extends a distance into the air and in or at the entry to the stack is located at least one turbine generator means which is used to extract energy from the heated air escaping the underside of the roof up the stack. The known system requires a very large roof area in order that sufficient air is heated to produce energy on a commercial scale. Another form of prior art device is able to use the suns rays passing through the roof cladding to heat the air and underlaying matter of the roofed area such that energy is extracted from the air as it makes its way towards and even up the stack as a first source from which energy is extracted but also included is means to produce energy from air which falls down the stack due to the injection of cooling fluid into the column of air in the stack such that the air is cooled and becomes heavier and more dense than that which lays below it in the stack such that turbine means are driven by the velocity of the cooled and dense air falling through its blades. The prior art device uses cooling fluids which are largely wasted and cannot be reclaimed such that it is a waste. These systems require very high capital outlays, take up very large land areas and are expensive to maintain because the roof structure through which the suns rays must pass is prone to decomposition and dust shading reducing the efficiency as the rays are stopped from heating that which underlies the roof by the dust and by the decomposing roof cladding becoming progressively more opaque. This disclosure teaches a new approach which significantly overcomes the limiting factors of the prior art such that a solar thermal engine is formed which has greater economic feasibility and does not require as a necessity a roof structure in order to capture the suns rays. Another shortcoming of the known tower arrangement is that he flow of air passing under the roof structure enroute to the tower has the effect of severely drying out the ground under the roof causing it to shrink such that the foundations of the roof structure can become destabilised and distorted leading to the potential breakdown in integrity of the roof structure overlying the volume to be heated.

### DISCLOSURE OF THE INVENTION

We have discovered that we may increase the efficiency of solar thermal uplift towers and variants of same by the inclusion of heat exchanger systems in to the updraft tract of the tower (the tower and the tract being the same term in the document). We use the heat from the sun to heat up a fluid in a collector system and then transport the heat so captured preferably by fluid piping means to the exchanger system so that the exchanger system can then impart at least some of the heat so transported to it into the air proximate the exchanger system in the updraft tract. The fluid flow between the collector means and the exchanger means may be by convection means (known as passive circulation) or by power pump means (known as active circulation).

The invention in a first broad form therefore is an engine being a new form of thermal uplift tower which includes at least one piped fluid solar thermal heat collection system for the collection of solar thermal heat which is connected directly or indirectly to at least one heat exchange system placed in the flow path of a hollow elongate tower such it heats the air in the air column causing it to rise in the tower. The tower being equipped with turbine means which may be placed at the entry to the stack or anywhere along its length such that turbine means blades are acted upon by the air passing through its blades to thereby spin the turbine means to drive a electric current generating device to produce a current for use. The solar thermal collection system may be coupled to at least one solar thermal concentrating system to increase the amount of heat energy available for the heat exchanger system if desired. What is more an inline series of concentrators may be used to add more heat if required. To allow the new uplift tower to continue to produce electricity through the night time and or also to boost capacity when desired or necessary it it envisaged that thermo means are used to store hot fluid which can then be flowed through the exchanger system as desired in the night periods and or when there is a need to boost the productivity due to desire, demand or even when there is cloud cover.

It is preferred that the fluid heated in the solar thermal collection system (hence forth called collector) is water but it may be an admixture of water with any other useful substance including but not limited to anti-freeze. Alternatively the fluid may be oil or an admixture of oil and another substance including but not limited to salt.

The invention increases the efficiency of any solar thermal uplift tower (engine) because it introduces a heat exchanger system it the tower flue (stack) or entry thereof. What is more we have discovered that collector means may be adapted to be on the outside wall of the tower and a heater exchanger system may be placed inside the flue such that heat trapped out side the tower can be exchanged into the air column inside the tower. The invention uses a collector system to heat up fluid (preferably water or water containing anti-freeze anti and or anti-corrosive substances) out side the tower and then flowed by pipe means the heated fluid to the inside or entrance of the tower to a heat exchanger system whereupon the air in the flue takes up the heat from the heat exchanger by radiance and by frictional contact with the exchanger surfaces. The flow system from collector to exchanger means can be passive relying on convection forces or it may be that there is included at least one power pump means to control the amount of flow as desired. Whether the flow is induced by convection or pump means the flow system may further include fluid flow metering means to control flow and or optimise the flow for modulation of the system out put.

The invention may be coupled with a roof system of any kind but preferably if it is coupled with a roof system that roof system preferably is a zero height roof system and the collector means located below the surface or the roof and or located above the surface of the roof and or be incorporated into the cladding material forming the top surface of the roof.

We have found that we may heat the air column within the tower by heat exchanger means which are fluid connected to collector means laying outside the uplift tower. The siting of the collector means may include the side of the uplift tower or any other suitable location outside the tower including a stand alone collector means or a collector means located on top of and or under neath a roof structure. The idea being to collect heat energy from the suns rays or indirectly via the medium of a roof structure and then to use pipe means to move the heated fluid into heat exchanger means located within or beside the air column to then have the air proximate the exchanger means take up the heat radiating from or emanating from the exchanger means so as the air is heated and energized it ascends by convection means.

The engine in another broad form includes a solar thermal uplift tower having at least part having collector means, the collector means being located on that side of the tower facing the sun at dawn such that heat energy in the form of the suns rays may be collected at the first opportunity of the day and thus increasing the over all efficiency of the tower at least as much as that amount of energy collected at and after dawn. The solar uplift tower presents a large surface to the sun at dawn being at or around 90 degrees to the sun at this time and therefore an excellent site at which to collect heat energy from the sun. Accordingly the invention includes the use of collector means on the outside of the tower or incorporated into the side of the tower facing the sun at dawn.

In an preferred embodiment of the engine a collector system is mounted on or above the ground and it is adapted to collect direct heat radiation from the suns rays and or the environment and it is connected to a heat exchanger system in a air column of and elongate uplift tower. The fluid heated in the collector means is piped through top exchanger means in the tower and exchanges the heat into the air column or portion of same so as to cause un updraft as the air is expanded and seeks to rise up the column to the opening outlet of the tower. The up moving heated air may be used to drive turbine means or the suction caused at the bottom of the tower caused by the evacuation of the heated air spilling out of the tower top pulls the impellor blades of the turbine to make the turbine spin on its axis. The turbine being connected to or otherwise coupled to an alternator means and or a generator means such that the alternator means or generator means is caused to spin on its axis to generate electricity. The alternator means or generator means with hence forth be called in this document generator or generator means.

In another preferred embodiment of the engine an uplift tower is created which is formed at the crest of a hill or mountain and below the entrance of the tower or at least a heat exchange means in the tower is sited collector means The turbine means being located below the exchanger means such that the rise of the air in the air column of the tower causes a partial vacuum between the exchanger means and the turbine thus sucking air through the turbine means causing the turbine means to spin around its spin axis to drive either directly or indirectly generator means.

It is preferable that collector means be included which are site such that as the sun moves through the sky the collector means is able to take full advantage of the angel of the sun to harvest as much heat as possible throughout the day. In this the ere may be a plurality of collector means and each adapted for collection of the optimum amount of sun heat at a given angle of the sun in the sky.

One of the many advantages of our uplift tower system engine is that the air in the air column may have heat added to it at any point along the length of the air column. This in not the case in prior art devices which can only add heat to the air about to enter the uplift tower. Another novel aspect of the engine allows heated air to be added to the rising air column at at least one point along the length of the column. This may be done by heat exchanger means and a flue system which is connected to the main flue system of the tower.

In another variation of the invention a gate is included along the length of the tower such that the gate can be opened and closed when desired. The advantage of this system is that the tower may be pulsed by the opening and closing of the air column. By this means it is possible to generate electricity in a pulse wise manner by allowing the air column to be opened and closed such that sufficient vacuum is formed in the length of the tower to generate uplift intermittently.

Another novel aspect of the engine is that the top of the uplift tower, that is the opening at the top of the tower of the internal flue of the tower may be adapted to have an elbow which is able to turn around the longitudinal axis of the tower such that the air passing the tower in the form of the prevailing wind can be used to suck the air out of the tower as it passes it by. The elbow being like wind vane which is steered by the wind so as the outlet orifice of the elbow is facing away from the wind. It is also envisaged the whole tower may be adapted to swivel on its long axis or axis parallel to same and that it have an elbow at the discharge end of the tower the elbow being at a transverse angle to the long axis of the tower and having a vane means such that wind passing by the discharge end of the tower is able to turn the tower around an axis parallel to the long axis of the tower such the outlet of the elbow is down wind and flows its air out in the direction the passing air is travelling thus causing the passing wind to create a partial vacuum in the top end of the tower allowing the rising air in the tower to rise more quickly than if it had to push that air at the tower top instead of the wind pulling the air out of the tower top.

It is preferred that one or more towers be included in the engine that are connected by flow passage means or which share an inlet orifice and or an outlet orifice.

In another broad embodiment of the engine collector means are used to trap heat energy from the environment and the suns rays so the heat can then be transferred by exchanger means into the air already in the uplift tower and the uplift tower has a first section which is the uplift section or portion and a second section or portion which is a downdraft tower section of the system. The uplift section extending up a slope of a hill such that the inlet is at the lower end of the hill and the downdraft section extending down the hill such that the discharge end is at the down slop end of the hill, upslope from the inlet and the discharge end is a cross over section extending between the end of the updraft section to the beginning of the downdraft section the whole thing looking like an upside down U wherein the middle of the U is the cross over section between the updraft section or portion and the downdraft portion or the combined updraft down draft tower of the invention. One end of the U being the inlet and the other end being the discharge or outlet end of the tower. The crossover portion may include an expansion chamber such that the energy of the risen air may be substantially used up in expansion and the down draft portion may include cooling fluid injection means such that air in the downdraft portion of the tower the air may be cooled by the water spray and gain in weight thus accelerating down the downdraft portion of the tower. The idea of this embodiment is that air is heated in the updraft portion of the tower system by heat exchanger means which is coupled to collector means to the outside of the tower, the collector means may be formed part of the updraft portion of the tower system or it may be at a distance from the updraft portion of the tower system and the air so heated by heat exchanger means rises up the updraft portion and uses its energy up as it rises and extends such that by the time it reaches the cross over portion between the updraft portion and the downdraft portion all or a significant portion of its energy has been spent and in the cross over portion the air expands its final stage and begins to get heavy enough again to fall down the downdraft portion of the tower system. In the cross over portion and or in the down draft portion cooling fluid (preferably water) is sprayed into the air which increases its density quickly so it falls down the downdraft portion. The updraft portion including turbine means and the down draft portion including turbine means. Preferably the turbine means in the updraft portion is located at or near the bottom of the updraft portion and preferably the turbine means in the downdraft portion is located at or near the discharge end of the downdraft portion so the full weight of the condensed air can work the turbine means at the discharge end of the downdraft portion of the tower system and the turbine means in the updraft portion being preferably at or near the intake end of the updraft portion of the updraft portion of the updraft tower so the as large a vacuum as possible can be formed above the turbine means in the lower end of the updraft portion. Preferably at least a portion of the cooling fluid sprayed into the air is collected by gutter means so it can be reused again and again or is allowed to flow into a stream or used for some purpose upon reaching the bottom end of the down draft portion of the tower system. It is preferred that the updraft portion gets larger in diameter as it ascends from its lowest end and the down draft portion gets smaller in diameter as it descends although neither or either of the updraft portion or the downdraft portion need be an exact circle in cross section but it is preferred so. It is also preferred that the updraft portion and or the downdraft portion include a number of stages along their length such that at a first distance along the updraft portion the cross sectional area perpendicular to the long axis is a first size and then higher up the updraft portion it is a greater size and the downdraft portion having a first cross sectional area perpendicular to its long axis at a first high portion of the downdraft portion and a second smaller cross section area down slope of the first portion which is smaller in cross sectional area than the first cross sectional area above it. In this way the updraft portion can have expansion stages and the down draft portion may include compression stages. It is also preferred that the cross over portion between the updraft portion and the downdraft portion include an expansion chamber which may be variable in volume so as to be able to adjust expansion ratio of the risen air as required as a means to adjust the performance of the tower system. It preferable that the updraft portion include heat collector means at a location along its length such that heat can be taken from the rising air if desired to in this way moderate the flow speed of the air in the updraft potion to alter the performance of the tower system, also the down draft portion may include heat collector means to further take heat from the air in the down draft portion so as to increase the density of the air in the downdraft portion to moderate the performance of the tower system by increasing the weight of the air in the down draft portion, also it is preferred in the cross over portion that there be included heat collection means so that the air risen to the cross over portion may be cooled so that it is will begin to contract in size and increase in density so it will fall down the downdraft portion of the tower. Preferably the cross over portion has at least one wall which is a heat collecting wall or is a water wicking membrane of fibre wall like a water wicking cooler wall. The air passing the wicking picks up moisture from the wicking which cools the air making it become denser and fall. The wicking may be fibrous mat-like structure or tendrils or the like. The invention relies on the fact that hot air rises. In some embodiments of the invention wherein there is included a downdraft portion the invention also relies on the fact that cold air falls.

In another broad form of the engine the updraft portion and downdraft portion are connected together by flow passage means to create a complete loop there being a plenum chamber or cross over chamber linking the upper end of updraft portion to the upper end of the downdraft portion and there being a plenum chamber of crossover chamber linking the lower end of the down draft portion to the lower end of the updraft portion. It is preferable that the upper plenum and or lower plenum be adjustable such that the distance between the upper plenum and the lower plenum can be altered to change the over all length of the loop. The lower plenum may include a cooling fluid reservoir of be connected to a cooling fluid reservoir so that cooling fluid may be collected and reused. It is preferable that said fluid be chilled by heat collection means in contact with the fluid.

For clarity herein we define the invention into five distinct versions of the invention, the first version is an uplift tower only version of the engine. The second version is an uplift tower connected to a downdraft tower version of the engine wherein the uplift tower intakes atmospheric air and the down draft portion discharges the same air which entered into and then fall down the downdraft portion of the engine such it discharges into the atmosphere. The third version of the engine is in the form of a complete or endless loop. The fourth version is in the form of an uplift portion connected to a downdraft portion which discharges into the bottom end of another updraft portion which is joined to a further downdraft potion whereupon the air is discharged into the atmosphere.

Endless loop and versions of the engine it can be formed such that it operates on Brayton and or Stirling cycle laws if desired.

The loop variants of the engine may be partly submerged in a water body to aid in cooling the down draft tract of the invention.

The updraft portion of the engine in its various versions may include a light permeable wall or window means which can allow the suns rays to pass into the inside of the updraft portion onto a collector and the rising air in the updraft portion

Cloud pistons (hereinafter called piston or pistons in plural) may be used in the engine to increase its performance. It is preferable that the piston is formed of steam. A first piston is formed of a ball of steam injected into the updraft tract above the turbine means. After the first piston has risen a distance further up the intake tract second piston is injected below the first piston such there is a gap between the lower face of the first piston and the upper face of the second piston. And both the second and first piston continue to rise up the updraft tract and then below the second piston is injected a third piston, it like the second being at a distance from the piston immediately above, this is repeated over and over again. Preferably the pistons are all of one charge so that they repel against each, that is, the next inline to itself. A hydrostatic machine may be used to produce the charge of steam forming each cloud and a non-limiting example of a machine for doing this may be an Armstrong machine. The steam is formed from heated water and may include a suitable contaminate such as camphor or any other useful contaminate. The air abpne the updraft turbine is heated by exchanger means and above the exchanger means is located a cloud piston forming steam injection unit, the hot air rises up the updraft tract and a piston is injected into the column of air as it rises, after the piston has ascended a distance another piston is injected which ascends, after a distance has accumulated another piston is injected an so on. The idea being to trap heated air between each piston and as the stack of piston rise the upper most piston is cooled the most and begins not to rise as fast as the one below it which compresses the air between the upper piston and the lower piston thus raising the temperature of the air trapped between it and the immediately below it next piston. Ideally the updraft tract gets larger as along the length of the tract such that it is its largest size (perpendicular to the long axis of the tract) at or around the top end which allows each piston to gradually expand on its ascent and slow in its speed of ascent whilst compressing the air trapped immediately below between itself and the next piston on the ascent which causes the air so trapped to rise in temperature and because each cloud is of the same charge they repel each other so that they do not meet on the way up the tract. When the first cloud reaches the cross over portion of the loop between the updraft tract and the down draft tract the first piston has expanded and cooled such it is almost to heavy to keep rising and is stationary almost by the time it reaches the level of the crossover portion and into which it is displaced sideways as there is a partial vacuum in the cross over portion because the air in the downdraft tract is falling. The upper crossover portion allows for further expansion of the first piston and it begins to collapse into condensate which rapidly chills the remnants of the piston and it falls down the downdraft tract as cooled air and water droplets and molecules. The downdraft tract tapers towards its lower end such it is larger in cross section at or near the upper cross over portion than it is as it approaches the lower end of the downdraft tract. The taper is such that it matches the decreasing volume of the falling piston remnant and cooled air which was previously heated air above it when it was ascending the updraft tract. As the air and piston remnant falls it picks up sped so the at the lower end of the downdraft tract it reaches it greatest velocity and strikes the turbine means in the lower end of the downdraft tract. In fact the temperature of the fallen air and piston remnant can have a higher temperature than what its temperature was on entry into the downdraft tract because it is compressed atop the turbine means as it tries to pass through the turbine means and the turbine extracts the heat in work it performs spinning on its axis. The piston remnants being water droplets and the air being cooled goes into the lower crossover portion of the loop between the lower end of the downdraft tract and the lower end of the updraft tract. The lower pressure below the turbine means in the lower end of the down draft tract which draws the air through said turbine means. The lower crossover portion has a greater pressure than that which is immediately above the turbine means which is in the lower end of the updraft tract and so is pushed through said turbine means to drive said turbine means around its axis. The air so pushed through is then heated by exchanger means so that it begins its ascent of the updraft tract and after it has risen a suitable distance along the length of the updraft tract a piston is injected below it which pushes the air higher up the updraft tract and immediately below the piston more air follows through the turbine means in the lower end of the updraft tract and another piston is injected into the updraft tract behind it and so on. Overlaying this sequence is what happens in the downdraft tract and that is as the first piston remnant moves from the upper cross over portion to the downdraft tract top end it is condensing into precipitate and raindrops begin to fall from it down the downdraft tract as a shower burst of drops driving the air beneath the drops and along side the drops down the downdraft tract by friction and by drag through the air in the downdraft tract and a space develops behind the fallen remnant to cause a lower pressure into which is pulled the second piston remnants which are condensing and falling behind the first piston remnants such that the second piston remnants form a rain burst of droplets and the air caught between each burst of precipitate is compressed between the precipitate of the first piston remnants and the second piston precipitate remnants such that its and density is increased but it is undergoing a loss of temperature at the same time. Generally speaking with versions of the engine which are loop version and which use cloud pistons the pistons may be formed of wet or of dry steam and may be charged or be uncharged. The charging may be performed by electro-friction or by electrostatic/hydrostatic machines means. If charged pistons are used then the tract in which it passes may be electrically insulated so that the charge is not dissipated and it is possible that the tract along which it passes may have a like charge to that of the piston so that the side of the piston it repelled from the wall/s of the tract it passes along. If the piston is charged it may be necessary to discharge the charge in the piston at a stage along the tract so the invention may include electrode means to which the charge in the piston may flow to dissipate into. The charge dissipated into the electrode means can then be used to form another charge piston for example of connected to earth or be used for a some other purpose. The electrode means can be a chilling surface or have a number of chilling surfaces on it.

Another embodiment of the engine includes an updraft tract which can discharge into the atmosphere at its discharge end and it can be adapted such that it can be selectively connected by crossover tract means to a downdraft tract such the risen air is redirected away from the discharge end of the updraft tract and can pass through the upper crossover tract into the downdraft tract where the air can be discharged from the downdraft tract discharge orifice however, the engine may further include a lower crossover tract which can be adapted to connect the discharge end of the downdraft tract to the lower end of the updraft tract such that the engine is formed into a loop engine variant of the engine.

Broadly speaking with relation to the versions of the engine the length of a tract in the engine may be selectively lengthened or shortened if desired to adjust the performance of the engine.

A preferred embodiment of the engine including a thermal updraft (or uplift) tower being an elongate hollow tube having an inlet means being an orifice through which air can enter the tower and having an outlet or discharge orifice through which air can pass from out of the tube into the atmosphere. The tower being ideally situated upon the top of a hill, the tower having turbine means and situated in the intake orifice means and each adapted to spin on a respective axis such that the passage of air into the tower through the turbine means and causes the turbine means to spin on their respective axes, the turbine means being connected either directly of indirectly to generating means. Mounted above the ground are collector means and each of which is connected to a respective thermo tank. The thermo tank means being fluid connected by pipe means to exchanger means which as can be seen are located within the updraft tract (tube). Air being in the tube of the tower being heated by the exchanger means such that it is less dense than that of the atmosphere and so it rises within the tower along the tube until it reaches the discharge orifice and spills into the atmosphere. The collector means is shown as a pipe means for collecting heat diffuse heat and direct rays from the sun and rises along the length of the collector means by convection into the thermo tank means. The collector means being akin to solar hot water heating means which are commonly employed to heat water for housing and pools and the like. The collecting means being preferably filled with a fluid which is water but may include antifreeze or other admixture material to the water. Alternatively oil or some other fluid may be used as the transport medium of the collector means as desired. The collector means may discharge the chill fluid which has been heated within them into a thermo means (insulated tank means for containing hot fluid) and the exchanger means off-taking fluid from the thermo tank means but this is not entirely necessary in that there may in an alternative arrangement be that the collector means is in direct fluid connection to the exchanger means. Also it can be seen that we have chosen to site the tower upon the crest of a hill so that the fluid heated in the collector means which are down slope of the tower can rise by convection means into the thermo tank means but this is only a preferment as it is possible that the fluid within the collector means is motivated along the circuit of the collector means and into the thermo tank means by pump machine means or at least assisted along the circuit of the collector means by pump machine means. Also the exchanger means fluid flow is shown operating by convection means but this is only a preferment as it is likely in many circumstances that the fluid is driven or at least partly driven along the circuit of the exchanger means by pump machines means. In an alternative arrangement the collector means circuit and the exchanger means circuit can be in direct fluid connection and pump machine means may drive or at least assist in the driving of the fluid around the circuit of the combined circuit of the collector means and the exchanger means. It is of course likely that the same tower could be erected on flat ground or even in a hollow if desired but it is preferred that the tower is sited atop a hill or mountain or other elevated position relative to the circuit of the collecting means. In a slightly alternative arrangement to that which is shown the collector means may be located under or above a roof or be formed from hollow members of a roof. It is envisaged that the collector means include photovoltaic cell means for converting at least a part of the sunlight striking the collector means directly into electrical energy accordingly the invention may include collector means which include photovoltaic cell means for the direct conversion of at least a portion of the sunlight striking it into electrical energy. In another alternative arrangement to that which is shown the collector means or at least one collector means of the system can be heated by means other than sunlight or diffuse heat from the environment. Other heat sources may be utilised as available or desired as there are a large number of potential heat sources which may be utilised, accordingly the invention is not limited to only collecting heat from the sun or diffuse heat in the atmosphere but can be adapted to source its heat from any suitable heat source including but not limited to a fire or other chemical reaction producing heat or from hot rock or lava or composting decomposing matter which is developing heat in the process of decay. It is likely that the updraft tower be formed of a number of tubes joined end on end and accordingly the invention may include tube means which are formed as separate components which are then joined together to form the updraft tower of the engine.

In another preferred embodiment of the engine being a thermal uplift tower being a hollow tube elongate along an axis and having inlet orifice means and outlet orifice means. The tower including an elbow in its lower end having a tract extension extending along an axis transverse to the long axis of the tower (updraft tract). The engine further including collector means and thermo tank means and heat exchanger means connected in a piped fluid flow circuit. It can be seen that the exchanger means is located within the updraft tract such that the air in the updraft tract can be heated by contact with the exchanger means and from heat radiating from the exchanger means. The engine is shown having turbine means located within the updraft tower and sharing the same axis of rotation as the generator means such that air passing through the inlet orifice can strike against the blades of the turbine means and thus cause the turbine means to revolve around its axis of rotation. The turbine means being preferably directly coupled to generating means. The collector means adapted to collect heat discharged from the sun. The inlet orifice being situated at the end of the lower portion of the elbow of the tower. It is to be noted that the engine has a inlet tract extending from an elbow of the updraft tract as a preferment and there may be no need in many circumstances for there to be an elbow and transverse extension accordingly the invention is not limited to having an elbow and transverse extension as it may be configured such that the updraft tract is simply a tube extending generally upwards with the turbine means preferably aligned along or parallel to the long axis of the updraft tract.

In another preferred embodiment of the invention the engine includes an updraft tower being a hollow tube and having an inlet orifice means and an outlet orifice means. Located in the updraft tower is a turbine means in being at least partially in the path of the flow of air along the updraft tract. The turbine means being located in the lower end of the tower (updraft tract) preferably having an axle shaft on which is mounted generator means for the production of electricity or hydraulic pressure from the spin of the turbine when said turbine is spinning. Preferably the turbine means is located within the updraft tract such that it is located in or close to the inlet orifice portion of the updraft tract and that air passing into the updraft tract through the turbine means will cause the turbine means to spin on its axis of rotation by aerodynamic principles. Preferably the engine includes more than one collector means and that said collector means are each in a fluid circuit which fluidly connects each respective collector means to the exchanger means which are placed in the updraft tract or under the roof. There may be three collector means for example and each being a complete loop fluid circuit with a respective exchanger means located in the flow path of the air in the updraft tract or even in some desirable circumstance before it enters the updraft tract. Preferably a respective collector means and exchanger means form a set which are linked together by a loop of piping which has the collector portion located outside the updraft tract and a portion being the exchanger means located within the updraft tract or under the roof. Preferably each of the said piping loops is adapted to pass through the side wall of the updraft tract or roof. As a non-limiting alternative to this arrangement the fluid loop pipe circuit of at least one collector-exchanger means set does not pass through the side wall of the tower but may enter and or exit the inside of the updraft tract by one or other or both of the orifices of the updraft tract (inlet, outlet). Preferably the updraft tower (tract) being a part of a roof system under which is a volume which is heated by the rays of the sun. The roof system being such that it allows sunlight to pass through its cladding and having side edges in a position of elevation relative to the ground and the side edge, air being drawn under the roof by means of the suction caused by the rise of air up the updraft tract of the tower. The collector means being located outside the updraft tract and roof system and being in fluid connection to exchanger means which exchanges heat captured by collector means into the air under the roof structure. The collector being located outside the updraft tract and being preferably in fluid connection with exchanger means inside the updraft tract to impart heat collected in the collector means into the air in the updraft tract. Preferably the turbine means is in direct connection to generating means but as a non-limiting alternative to this the turbine means may be connected to the generating means by a gear train or by belt or chain means or any other suitable connection or interconnection means including but not limited to hydraulic means or magnetic means. It is preferable that the generator means used throughout the embodiments of the invention are a producer of electric current but it may be that a turbine means in the invention drive hydraulic pump means which then drives a hydraulic engine by fluid pressure means coupled to the generating means or even that the turbine means drives a hydraulic pump and the hydraulic fluid under pressure from the driving of it is used for a industrial purpose.

In another preferred embodiment of the invention the engine takes the form of updraft tower being a hollow tubelike structure having inlet orifice means and an outlet orifice means. The engine further including a collector means in which are preferably in direct fluid connection to exchanger means wherein the collector means portion of the collector/exchanger system is located outside the tower and the exchanger portion is located inside the tower such it is contactable by the air adjacent it in the updraft flue (tract). The exchanger means may be the wall of the updraft tract if desired Preferably exhaust fan means are provided for the outlet orifice end (upper end) of the tower which is. It exhaust fan of the tower such the exhaust fan means spins on an axis and that the fan axis is aligned parallel to the long axis of the tower although this may not always be practicable. Preferably the exhaust fans means is of a type which has vanes which are both driven by the passing wind and which also serve to pump air out of the updraft tract. The engine including collector means preferably in direct fluid connection to exchanger means located within the updraft tract. The collector means being adapted to capture heat from a distant location outside the tower, and, the exchanger means for exchanging the heat collected by the collector means into the contents of the updraft tract such that the air (contents) is heated and expands so it rises in the updraft tract in the direction of the outlet orifice. The collector means being adapted to collect heat from the sun and also preferably from the environment which has be heated from the sun.

Another preferred embodiment of the invention taking the form of a updraft tower being a hollow tubelike structure including at least one inlet orifice means and including at least one outlet orifice means. The engine further including a collector means being preferably in direct fluid connection with a heat exchanger means to form a heat moving set wherein the collector portion of the set is located outside the updraft tract and the exchanger portion of the set is located inside the updraft tract such it is contactable by the air adjacent it in the updraft flue (tract) of tower or that it may radiate heat carries into the contents of the updraft tract. Preferably at least one exhaust fan means is included at or in the outlet orifice end of the tower which is provided to help lift the contents of the updraft tract out of the tower into the atmosphere. Preferably the exhaust fan means is driven by wind passing by the tower such the exhaust fan means spins on an axis, but, the exhaust fan means may be driven at times by power machines means. Preferably the exhaust fan means being of a type which has vanes which are driven by the passing wind and which also has vanes which serve to pump air out of the tower (updraft tract). Preferably the axis of rotation of the exhaust fan means is parallel to the long axis of the tower but can be at any suitable angle relative to the long axis of the tower as desired or practicable. The engine including at least one collector means adapted for capturing heat from a location outside the tower and the exchanger means for exchanging the heat collected by the collector means into the contents of the updraft tract such that the air (contents) is heated and expands so it rises in the updraft tract in the direction of the outlet orifice. The collector means being adapted to collect heat from the sun and the environment which has be heated from the sun.

Another preferred embodiment of the invention taking the form of an updraft tract including at least one inlet orifice means and including at least one outlet orifice means. The engine including at least one collector means being preferably in fluid connection with at least one exchanger means located within the updraft tract and the engine further including at least one steam piston injection means being adapted to inject intermittently shots of steam into the air in the updraft tract and the shots of steam being like pistons which push the air above them along the tract and which suck the air below them along the updraft tract.

In another preferred embodiment of the invention the engine takes the form of an updraft tower having a lower end including at least one inlet orifice means and including at least one outlet orifice means at its upper end. The engine including at least one turbine means for extracting work from air flow in the updraft tract and adapted to drive generating means. Preferably the engine including at least one inlet orifice means opening into a volume located under a roof which is preferably suspended above the ground. The engine preferably including a number of collector means and may for example include a first solar collector means in fluid connection to or fluid connected to a surface of first exchanger means located in a location within the updraft tract or wall of the updraft tract by loop pipe means from the collector means or intermediate container there between such that heat collected from a distant location outside the tower may be transported by fluid means between the first collector means and the first exchanger means and from there into the air proximate the first exchanger means which is at least partially located within the updraft tract. The engine may further include a second collector means located not within the tower or under the roof and the said second collector means being preferably adapted to be connected/linked to second exchanger means which is at least partially located within the updraft tract for the purpose of heating air proximate it in the updraft tract, the second collector means adapted to collect heat from the suns rays and diffuse heat from the environment and there being preferably fluid piping means along which fluid can flow to transport the heat collected to the second exchanger means. Preferably the engine further includes a third collector means being located above the roof and being in direct fluid connection preferably to a third exchanger means being located within the updraft tract for exchanging heat into air adjacent said third exchanger means being located at least partially within the updraft tract. Preferably the air under the roof has had heat added to it by radiation from the roof and by coming into contact with heated members of the roof. Preferably the first collector means is adapted to gather heat from a distant/remote/discrete location away from the tower and the heat is then preferably transported along pipe means in a fluid medium to the first exchanger means which is located in a location along the length of the tower being preferably a location located above at least one turbine means in the tower to cause the air at that location to be heated up and by the exchanger surfaces of the first exchanger means. Preferably the second collector means is adapted to collect heat from a location outside and remote from the tower and is preferably connected by fluid piping means to the second being preferably above at least one turbine means in the tower or inlet orifice of such to at least heat the air proximate it in the updraft tract to cause the air there to expand and rise within the updraft tract. It is preferable that the roof structure is a zero height roof structure including tension members as disclosed in PCT AU 2008 000246. Preferably the passage of the air through the inlet orifice means passes through the turbine means and then past the first, second and third exchanger means in a direction along the long axis of the updraft tract and then out the outlet orifice in turn but the order may be altered if desired. And preferably the passing of air through and/or past the turbine means drives the turbine means around its axis to extract work from the air in its passing. We have found that we can heat the air in the air column in the tower by way of heat exchanger systems. It is preferred that the heat collected by the collector means is taken up by a transport medium being a fluid piped through a piping system which is a loop system from the collector means to the heat exchanger element means located at least partially within the air column in the tract so that air is thereby energised to expand and rise up the tract which is a considerable improvement over what would be the case if the updraft tower were fed by heated air sourced from under a roof structure. The invention in many respects being superior to that which is know because in part it provides a way to deliver heat to the air already in the updraft tract and thereby substantially increases the out put of updraft tower over that shown in the prior art. The new system of the invention may include one or more exchanger means located within the air column of the updraft tract. There are a variety of locations where collector means may be sited relative to the roof structure and the tower and the invention is not limited to a single location as being the only location it may be sited.

In another preferred embodiment of the invention the engine is provided with more than one updraft tract and in an especially preferred embodiment it is provided with two updraft towers. The engine being a multi function engine which can be switched from operating as an updraft only engine system into an updraft and downdraft engine or even into a closed loop engine. Preferably the gas flow direction in the loop form of engine is clockwise. Preferably the multi function engine structure being such that there is included at least one upper cross over tract which includes at least one door/gate means which may be preferably selectively operated to cause the airflow passing up an updraft tract to bypass its respective the outlet orifice and travel along the said at least one upper crossover tract at least one other updraft tract so the air can fall down the updraft tract and, the multi function engine construction being such preferably that it includes at least one lower crossover tract to link the bottom end of each of the updraft tracts together sin order that air may pass between the lower end of the updraft tracts in a first direction. Basically in this loop version of the engines multi-functionality air that would circulating around it in one direction but which can be operated such that it functions as an updraft version of the engine or an updraft and downdraft version of the engine. Preferably the inlet orifices needed to provide this modality have gate or door like means which may be butterfly gate means or any other suitable gate or door means which can be selectively operated to close the bottom end (lower crossover tract portion) of the engine off from the atmosphere into a loop at will and the upper ends of the updraft tracts having gate means 11a and 11b which can be selectively operated to close the top end of the updraft tracts off from the atmosphere such that the air in the engine must travel around the loop created by the selective use of the gate means of the invention. Depending on which passage the gate means of the invention are caused to close or open the engine can be forced to operate in a number of different ways eg as an updraft only version of the engine, as an updraft and downdraft version of the engine and as a endless flow loop version of the engine. The engine including collector means and exchanger means tin fluid connection with each other preferably to convey and introduce heat into one or other of the updraft tracts to provide at least part of the energy to the air in the engine so it expends and rises in at least one of the updraft tracts as desired. The engine may also be provided with at least one chilling water supply piping system which may be adapted to include pressure pump means for the pressurising and supplying of chill fluid spray injection means to cool the risen air which has moved into the upper crossover tract or updraft tract which is converted into a downdraft tract in modalities of engine operation as a updraft tract and downdraft tract engine or as a endless loop version of the engine. Preferably the chill water is stored in the tower structure in a cistern means located at or around the floor of the lower crossover tract. Preferably the chill water injection means is adapted to inject chill water into the air stream of the upper crossover portion of the engine selectively as required in modalities of engine operation wherein the air does not just pass up an updraft tract and then out into the atmosphere but at least descends again in at least one of the updraft tracts which has been converted into a downdraft tract by the selective use of gate means. Preferably there is provided in at least one of the updraft tracts turbine means which are adapted to extract work from the passage of the air through or by them. Preferably at least one of the turbine means in the engine is bi-directional in that it can extract work from the passage of gas through it when the air is travelling up the updraft tract and when it is passing down the updraft tract depending upon the selective opening or closing of the gate means of the engine. It is preferable that the collector means is a solar thermal fluid heating system which includes a portion of a loop of piping or tube means which is heated by the sun and which is in fluid connection with exchanger means in at least one of the updraft tracts.

In another preferred embodiment of the invention an engine is formed including at least one updraft tract and including at least one downdraft tract which are closely siamesed to each other and connected to each other by at least one upper cross over tract such that the respective upper end of the updraft tract and the respective upper end of the downdraft tract are adapted to be connected to each other such that air is allowed to flow up the said updraft tract and then through to the upper end of the down draft tract (when we say upper end in this specification we mean that end closer to the sky than the lower end which is further away from the sky than the upper end, in other words what one would normally mean upper and lower to be relative to each other and to a man standing upright on the ground) where it can then commence to flow down the downdraft tract. At least one of the updraft tracts is fitted with at least one exchanger means adapted to impart heat energy into the air stream of a respective updraft tract and the exchanger means is connected to collector means which absorbs heat energy from a heat source which is ideally the suns rays. Preferably the upper crossover tract portion being an upper expansion chamber and being a portion of the downdraft tract such that the air which has risen up the updraft tract and has moved into the upper crossover tract portion of the system may be rapidly expanded and so cooled so that it becomes dense enough to commence to fall down the downdraft tract. Preferably and if required chill fluid may be injected and entrained into the air of the upper expansion chamber so as to further cool it and increase the speed of its fall down the downdraft tract. It may be necessary in some operating conditions to chill the air in the upper expansion chamber with chill spray introduction means before it begins or can begin to fall down the respective downdraft tract depending of the heat it was heated to by the respective exchanger means in the updraft tract. Preferably the injection of chill water is such that it is intermittent or but I may be desirable that it be constant or that it is variable in flow so as to proportionally match the condition of the air in the upper expansion chamber with regards to the heat the air is carrying in the upper expansion chamber. Preferably the upper or lower crossover point walls are variably positionable in height relative to the bottom of the updraft tract and the bottom of the downdraft tract and the height is variably adjustable by adjustment means which may be a for example but not limited to hydraulic ram of threaded adjustor means or any other mans with which to adjust its height position such that at least the upper crossover tract lower crossover point surface is moveable inline with the long axis of the respective siamesed updraft and downdraft tracts of the engine. Furthermore the engine may be adapted to include at least one steam injection means adapted to inject at least one shot of steam into the ascending air of at least one of the at least one updraft tract of the engine. The addition of steam into the air in the updraft tract being adapted preferably to add heat to the air in the updraft tract it comes in contact with and the steam being lighter than air moves up and along the updraft tract until it reaches the upper crossover expansion chamber wherein on expansion of said steam in said upper expansion chamber it at least begins to collapse from a steam state into a water state such that droplets are formed which fall down the respective downdraft tract so carrying and pushing air in the downdraft tract down the downdraft tract towards the bottom of the downdraft tract and through preferably the turbine means located there and then out preferably through at least one outlet orifice of the respective downdraft tract. Preferably the updraft tracts and the downdraft tracts are of the same length as each other but they may be of unequal lengths relative to each other if desired and this holds true for all the various embodiments of the invention.

In another preferred embodiment of the invention an engine is formed including an updraft tract overlaying a cliff such that the inlet orifice of the updraft tract is adapted to be located at or around the cliff base and, a outlet orifice means is adapted to be located above the level of the top of the cliff. Included into the updraft tract are exchanger means for energising with heat air passing by the exchanger means up the updraft tract thus causing the air heated by it to rise in the updraft tract by making it expand and become lighter. Ideally the engine is sited along the Great Australian Bite where there is a fairly constant air flow from south to north or from south west to north east. Because of wind direction and the impediment of the cliff face to it air at the bottom of the cliff the air may become pressurised having air built up and stacked on top of it. In a first modality of operation when the wind is blowing at least partly directly at the face of the cliff the updraft tract having its inlet orifice at or near the bottom of the cliff the air may flow into the inlet orifice under pressure and then forced up the tract and out the outlet orifice located above the top of the cliff face. The upper end of the tract being extended in its length in line with the wind direction and the outlet orifice facing away from the wind direction to allow for the air passing through it to enter the atmosphere travelling in the same direction as the wind is travelling. The wind so passing the outlet orifice causing suction of the outlet orifice and helping to pull air out of the tract in doing so. The system can be operated in reverse modality such that wind from an area not at the cliff base but in the same direction the cliff face is directed to can be forced into the outlet orifice and down the tract to be expelled out the inlet orifice at or near the cliff bottom. The tract adapted to include at least one turbine means preferably adapted to extract work from the passage of air in either direction along the tract as desired and as the wind conditions allow. The upper end of the tract can be swivel mounted to a mid portion of the tract structure so it can be aligned with the wind flow to increase the suction of the outlet orifice end or to increase the pressure at the inlet orifice end as desired and allowed by wind direction. In some operating conditions the engine may be operated without need of exchanger collector means however it is preferred that in all circumstances heat is added to the air in the tract by exchanger means and that collector means be adapted to use a heat source namely the sun rays to capture the heat required for this purpose. Preferably the axis of swivel for the tract components is aligned perpendicular to the horizon although any suitable angle relative to the horizon may be adopted if practicable and if desired. When wind is blowing towards the outlet orifice end located above the top level of the cliff there is a partial vacuum at the cliff base which helps to draw air out of the inlet orifice located at the cliff base or near thereto. When we say at the cliff base or close thereto we mean at a distance between the cliff base and the cliff top. The outlet orifice located above the cliff top may be located at the end of an ram extension of the of the tract which lays along or inline with the surface of the ground at the cliff top or it may be that the tract extends a distance above the ground at the cliff top and then an elbow extension extending which is swivel mounted preferably so that it can align itself with the wind direction and the air passing out the orifice can be in the direction of the wind flow. The system may be used in conjunction with any cliff anywhere in the world suitable. It is preferred that the orifices of ends of the tract are trumpet shaped. It is preferable that chill water be added to the air flow in the tract when the device is operating such the air flowing from a point above the top of the cliff to below the cliff top and thermal energy may be added to the air when it is passing from the cliff base to a location above the cliff top by exchanger means. Preferably venturi means are incorporated into the tract to increase the air speed flowing through the turbine means. It can be seen an ideal embodiment that the tract is doglegged in shape having a first elbow and arm at the cliff bottom and a second elbow and arm extending at the cliff top. The top and the bottom arm extensions at there respective elbows from which they extend are preferably swivel mounted to a static in terms of rotation mid portion of the tract to allow them to be selectively aligned for the prevailing wind conditions, as desired. This same device could be mounted onto a mountain to the same effect with the inlet orifice located at a down slope location of the mountain and the outlet orifice end located above the mountain. In fact the tract could be adapted to pass through a portion of a mountain. And so it could with a cliff as well in that it may not be needed that the tract overly the cliff face but that it can be adapted to pass through a portion of the cliff face if desired. Chill water may be sourced from any convenient location as desired but if the engine is located along a coastline it is preferred that the source is the ocean. The same can be said if the engine is sited near a lake or other water body

In another preferred embodiment the invention is configured such it forms an endless loop engine having an updraft tract and having a down draft tract which are connected together at their respective top and bottom ends by cross over tract means, a upper cross over tract means to link the top ends together and a bottom crossover tract means to link their respective bottom end together. The engine including a upper expansion chamber at the top end of the downdraft tract for the expansion of air which has passed up the updraft tract and through the upper crossover tract into the down draft tract portion of the loop. The upper expansion chamber allowing air which has made its way to it to rapidly expand and thereby lose its heat in the work of expansion and thereby grow in weight such that it begins to fall down the downdraft tract portion of the loop. The may be equipped with chill fluid introduction means having chill fluid injection nozzle means which are adapted to entrain chill fluid into the air in the upper expansion chamber further taking heat from the air causing it to further cool and become dense in order that it will fall down the downdraft tract portion of the loop or be at least far easier to draw down the downdraft portion of the loop. Preferably the chill fluid is water but any useful safe for the purpose fluid can be used. The lower crossover tract portion may be adapted to include cistern means for the collecting of chill fluid spent in the cooling of air in the upper expansion chamber and down the downdraft tract. Preferably there is provided chill fluid introduction means at intervals along the length of the downdraft tract and these may be adapted to be selectively operated to reduced the temperature of the air passing along the downdraft tract as it passes each of the introduction means. The cistern is adapted preferably to be connected to heat collector and exchanger means to allow the fluid in the cistern means to be cooled after it has been spent and collected in the cistern portion. The exchanger means servicing the cistern being adapted to dump heat it has holds into a cooling source for the fluid in the cistern means. In other words the chill fluid which may have been introduced into the air stream in the system will have taken up heat from the air in the system it has come in contact with and therefore may need in some circumstances to be cooled in order that it be usefully cool enough for the purpose of chilling air in the upper expansion chamber and downdraft tract portions of the loop. The downdraft tract is preferred to taper down from its biggest cross sectional area perpendicular to the long axis of the downdraft tract located at the upper end of the downdraft tract to its narrowest cross sectional area perpendicular to the downdraft tract long axis in a location located towards the bottom end of the downdraft tract where there is ideally located at least one turbine means for extracting work from the air which is falling down the downdraft tract. The said turbine means located in the bottom end of the downdraft tract sits above the lower crossover tract and directly below the said turbine means the cross sectional area of the lower crossover tract is preferably is larger than that cross sectional area of the downdraft tract immediately above said turbine means such that lower cross over tract includes a expansion chamber and that the air that passes through said turbine means in the bottom end of the downdraft tract can be expanded rapidly to work heat from it. The lower end of the updraft tract is preferably equipped with turbine means for extracting work from the air which is drawn through it as it passes up the updraft tract from where it was in the lower crossover tract on its way to the upper crossover tract. Immediately before the turbine means at the lower end of the updraft tract is preferably a compression chamber portion of the lower crossover tract which is a is adapted to taper towards the turbine means in the lower end of the updraft tract such that as the lower crossover tract walls approach the said turbine means it narrows. Above the said turbine means is preferably located at least one exchanger means with which to impart heat captured by collector means outside the tower into the updraft tract. The collector means being a solar collector means of preferably fluid flow type akin to that which is used to heat water in houses and swimming pools. The said collector means may be formed in combination with photovoltaic cell means such that a greater portion of the energy provided from the sun is harnessed to good use. The engine further including turbine means located at or around the top of the downdraft tract to extract work from the air falling out of the upper expansion chamber down the downdraft tract. The turbines of the engine each driving at least one respective generator means to produce electricity. However it is to be noted that the engines of the invention may be used to produce hydraulic pressure as well as or in replacement for electrical energy if the generator means is a hydraulic pump means. Preferably each of the generator means spins on the same axis as does the respective turbine means spins on but this need not be so in many instances as the turbine means shaft may engage by gear means with a shaft of the generator means which is offset from the axle of the turbine means, or there may be a gear train or chain or belt drive system utilised to join a respective turbine means to a generator means of the engine, this is generally so with any of the various embodiments of the engine contained herein. The turbine means at the bottom of the downdraft tract and the turbine means at the top of the downdraft tract may be adapted to be mounted on the same axle shaft if preferred. Preferably the turbine means at the top end of the downdraft tract and the turbine means at the bottom end of the downdraft tract are of differing volumetric throughput such that the turbine means at the top end of the downdraft tract is larger that the turbine means at the bottom end of the downdraft tract. The engine may be adapted to include only one or more turbine means and the placement thereof is a matter of desire and practicality in may instances.

In another preferred embodiment the invention is configured in the form of a endless loop engine which utilizes cloud pistons which are adapted to be injected by steam piston injection means at preferably intermittent intervals into the moving airstream in the updraft tract portion of the loop. Each of the pistons having a crown and a crown underside and having side wall/s. The loop including updraft tract means and including down draft tract means and the loop having a upper cross over tract portion and a lower cross over tract portion. The upper cross over tract portion adapted to join the upper end of the updraft tract to the upper end of the downdraft tract and the lower crossover portion adapted to join the lower end of the downdraft tract to the lower end of the updraft tract. The updraft tract and the downdraft each adapted preferably to include respective turbine means and to have generator means stationed within them for extracting work from the passage of air through them as the air makes its way around the loop. In operation the air within the loop preferably circulates around the loop in a clockwise direction. The updraft tract adapted to include exchanger means to impart heat energy into the air passing it by up the updraft tract and the downdraft tract portion adapted to include heat collector means to take heat from the air passing it in the downdraft tract. The exchanger means situated in the updraft tract being preferably adapted to be located above the turbine means in the updraft tract (but it can be located under the turbine means in the updraft tract if desired it being a preferment that it be located above the turbine means). The downdraft tract preferably adapted to include turbine means at a location along the length of the downdraft tract such that the location is at the bottom end or near the bottom end of the downdraft tract. Preferably there are collector means adapted to be located in the updraft tract for collecting heat from the air stream in the expansion chamber of the upper end of the downdraft tract and preferably by means of fluid connection the heat is transported to expansion means adapted to be located in a cooling medium wherein the heat collected from the upper expansion chamber by the said collector means can be dumped. Preferably there are collector means adapted to be located in the upper end of the downdraft tract (expansion chamber portion of same) The engine being preferably configured to have steam piston injection means which are preferably adapted to be operated to intermittently inject a shot of steam or shots of steam to form cloud pistons into the airstream in the updraft tract above the level of the turbine means adapted to be located in the updraft tract. The steam within the pistons being preferably electrically charged (dry or wet steam as desired) and the wall/s of the updraft tract being electrically insulated such it they have no charge or being adapted to be insulated from the ground but electrically charged with the same polarity as that the steam piston carries. Ideally the steam piston progresses along the updraft tract until it moves into the upper crossover portion of the loop where it discharges onto at least one special collector means which includes electrode means (although the electrode means may be separate from the collector means if desired). Preferably the cloud piston makes its way along the updraft tract until it reaches the upper cross over tract portion of the loop and as it passes into the expansion chamber at the top of the downdraft tract and it is the drawn towards the heat collector electrode means which is adapted to be in the expansion chamber (upper cross over tract) the said collector means carries an opposite charge to that which the piston carries and the piston is induced to discharge its charge onto the said special collector means and in the coming of it in contact with said collector means which ideally colder than itself to thereby lose both electrical energy and heat in it the process. The cloud piston having lost a significant portion of its energy condenses into water droplets which are heavier than air and so fall down the downdraft tract to be collected in the bowel or cistern of the lower crossover tract portion of the loop. A form of magnetic refrigeration in use! The loop engine can include discharge electrodes in the downdraft tract or lower crossover tract to pick up any still charged components of the cloud piston/s if required or desired. The steam used to form the piston/s may be charged by a steam charging machine including but not limited to an Armstrong machine. The collector electrode apparatus located in the upper crossover expansion chamber is preferably led to earth.

In another preferred embodiment of the invention an engine is formed in the configuration of an endless loop engine which is adapted to two updraft tracts and to include a single downdraft tract, the two updrafts tracts adapted to be connected at their respective upper end to the upper end of the downdraft tract by a upper crossover tract and the two updraft tracts adapted to be connected each at their lower end to the lower end of the downdraft tract by a lower crossover tract. The loop system adapted to resemble two endless loops siamesed in their flow down the length of the downdraft tract. Each of the updraft tracts are adapted to preferably include exchanger means for imparting heat captured outside the engine by collector means into the air streams of the updraft tracts at locations adapted to lay above the turbine means situated in their respective lower end. The downdraft tract adapted to lay preferably between the flanks of the updraft tracts although this need not be so in some circumstances. The turbine means in the lower end of each updraft tract adapted to extract work from the passage of air through them as the air cycles through the loop of the engine and passing through them The downdraft tract may also be adapted to include turbine means preferably located at or around its lower end for extracting work from the air falling down the downdraft tract. Chill fluid injection means may be located in the upper crossover tract which may also double as an expansion chamber at the top end of the updraft tracts and the top end of the downdraft tract. The loop engine being preferably adapted to use steam pistons which are preferably adapted to be injected by steam piston injection means adapted preferably to be located above their respective turbine means. In the upper expansion chamber is preferably adapted to be located combined electrode and chill fluid injection means for the purpose of attracting the cloud pistons and for allowing the steam pistons to discharge the charge they carry into. The steam pistons preferably being charged by steam charging means and the walls of the updraft tracts being preferably adapted to be electrically insulated and or adapted to be charged with a charge being the same polarity as that the steam pistons carry. The wall/s of the upper crossover tract adapted to be preferably electrically insulated or portion of same is and carrying the same charge as that the pistons are charged with and/or having portions charged with an opposite charge than what the cloud pistons carry. The lower crossover tract preferably including cistern means to capture water condensate falling down the downdraft tract. In operation one of the air motion travelling in a path in a clockwise direction and air flow travelling a path in a anti clockwise direction such the two motions coalesce in the downdraft tract such they are travelling in the same direction down along the downdraft tract towards the lower cross over tract as each other with the air in a first updraft tract travelling clockwise and the air in the second updraft tract travelling in a anti-clockwise direction. The engine being preferably configured to run on atmospheric air but can be configured to run on any suitable gas/air including but not limited to the following examples: carbon dioxide, carbon monoxide, nitrogen, electro-conductive gasses. Preferably the chill fluid is water but any suitable liquid may be used or admixture of liquid and any other suitable matter including solid matter. The chill water may form a lower wall of the lower crossover tract preferably.

In another preferred embodiment of the invention an engine is configured such it includes two updraft tract sand two downdraft tracts. A first updraft tract adapted to have inlet orifice means and at the upper end of said first updraft tract is a first crossover tract adapted for connecting the first updraft tract to a first downdraft tract which is adapted to be connected at its lower end to a second updraft tract by a lower crossover tract. The second updraft tract is adapted to be connected to a second downdraft tract by a second upper crossover tract and the second downdraft tract at its lower end being adapted to include outlet orifice means. The first crossover tract being adapted to include preferably a turbine means and the first downdraft tract preferably adapted to include another turbine means. Preferably the second updraft tract is adapted to include a turbine means and the second downdraft tract is adapted to include a turbine means. The gas flow through the engine is adapted to begin by passing through the inlet orifice means and then up the first updraft tract, then down the first downdraft tract and then up the second updraft tract and then down the second downdraft tract and then out the outlet orifice. The turbine means in each tract being adapted to extract energy (work) from the passage of gas (air) through the system. Collector means coupled with exchanger means are used to heat the air in each of the updraft tracts so that in operation the air in the updraft tracts rises in the tracts into the upper crossover tracts into which they feed. The upper crossover tracts being in the form of expansion chambers for allowing the air to expand and thereby lose its heat in the work of expansion. The upper crossover tracts preferably adapted to include chill fluid introduction means in the form of injector means which may be adapted to act intermittently or alternatively constantly inject chill fluid into the air travelling through them if desired. There being a cistern arrangement adapted to be located at the floor or forming the floor of lower crossover tract preferably. The first updraft tract being adapted to be preferably of a different total length to that of the second updraft tract such that the first updraft tract is longer than the second updraft tract. The first down draft tract adapted preferably to be of a different total length to that of the second downdraft tract such that the first downdraft tract is shorter than the second downdraft tract. The engine may further include chilling water injection means for cooling the air in the downdraft tracts of the engine and any of the chill water injection means may include one or more injection nozzles as desired. It is preferable that more than one injection nozzle is disposed within the upper crossover tracts and/or downdraft tracts but in many circumstances only one will be needed accordingly the invention is adapted to include at least one chilling water injection nozzle means. If chilling water is utilised in the system it may be adapted to be wicked or entrained by other means other than injection nozzle means into the air flowing along the downdraft tracts or through the upper crossover tracts by wick means which can be of any useful wick shape but it is preferred that the wick means be either mat-like wall or curtain or tendrils being elongate and protruding into the air stream. Chilling fluid injection means may be pressure driven utilising power pump means as or it may be gravity driven system if desired and practicable. The engine being preferably adapted to extract energy with its turbine means in the updraft tracts and by its turbine means in its downdraft tracts, although one or other of the turbine means may be selectively turned off or taken out of service or system if desired. It is preferred that chill fluid used in the system be captured by cistern means form from or including the lower most surface of the lower crossover tract portion of the loop. The engine 10 further including outlet orifice means 102a for the first updraft tract which is adapted to be selectively opened and selectively closed as desired such that the engine may be adapted to be selectively operated on only the first updraft tract mode when desired. The adaptation of selective opening and selective closing of the outlet orifice of the updraft tract being performed preferably by door means which are preferably hinged and which if so are adapted to swing open away from the direction of flow or towards the direction of flow but any form of gate or door means may be adopted for the purpose of opening or closing a tract of the loop.

### BRIEF DESCRIPTION OF THE DRAWINGS

FIG. 1 is a sectional schematic isometric view of the invention.

FIG. 2 is a sectional schematic side view of the invention.

FIG. 3 is a sectional schematic side view the invention.

FIG. 4a shows a sectional schematic side view of the invention.

FIG. 4b shows a sectional schematic side view of the invention.

FIG. 5 shows a sectional schematic side view of the invention.

FIG. 6 shows a sectional schematic side view of the invention.

FIG. 7 shows a sectional schematic side view of the invention.

FIG. 8 shows a sectional schematic side view of the invention.

FIG. 9 shows a sectional schematic side view of the invention.

FIG. 10 shows a sectional schematic side view of the invention.

FIG. 11 shows a sectional schematic side view of the invention.

FIG. 12 shows a sectional schematic side view of the invention.

FIG. 13 shows a sectional schematic side view of the invention.

FIG. 14 shows a sectional schematic side view of the invention.

FIGS. 15a and 15b show sectional schematic end views of the invention.

FIG. 15c shows a sectional schematic isometric view of the embodiment shown in FIGS. 15a and 15b.

FIG. 16 is a sectional schematic end view of a Mopped version of the invention showing an idealised scale fro temperature difference in said form of engine.

FIG. 17 is a sectional is a sectional end view of a muliti looped version of the invention,

FIGS. 18 to 23 show sectional side views of various arrangements for the updraft tract versions of the invention.

### DETAILED DESCRIPTION OF THE DRAWINGS

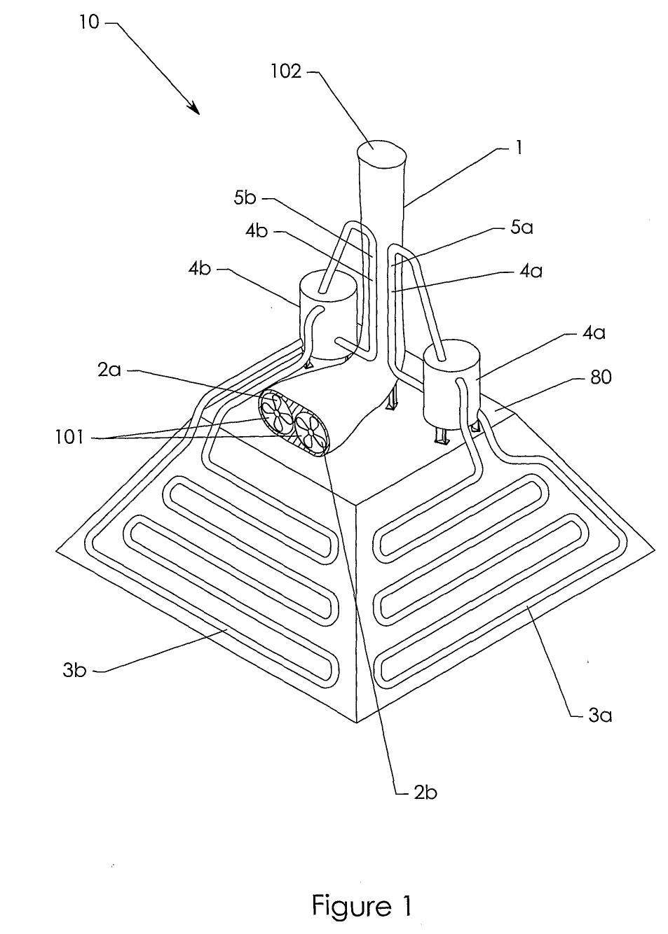

FIG. 1 shows a schematic sectional isometric view wherein is shown an engine according to the invention including a thermal updraft (or uplift) tower 1 being an elongate hollow tube having an inlet means 101 being an orifice through which air can enter the tower 1 and having an outlet or discharge orifice 102 through which air can pass from out of the tube into the atmosphere. The tower being ideally situated upon the top of a hill 80, the tower 1 having turbine means 2a and 2b situated in the intake orifice means 102 and each adapted to spin on a respective axis such that the passage of air into the tower through the turbine means 2a and 2b causes the turbine means to spin on their respective axes, the turbine means being connected either directly of indirectly to generating means (not shown). Mounted above the ground are collector means 3a and 3b each of which is connected to a respective thermo tank 4a and 4b. The thermo tank means being fluid connected by pipe means to exchanger means 5a and 5b respectively which as can be seen are located within the updraft tract (tube). Air being in the tube of the tower being heated by the exchanger means such that it is less dense than that of the atmosphere and so it rises within the tower along the tube until it reaches the discharge orifice 102 and spills into the atmosphere. The collector means is shown as a pipe means for collecting heat diffuse heat and direct rays from the sun and rises along the length of the collector means by convection into the thermo tank means. The collector means being akin to solar hot water heating means which are commonly employed to heat water for housing and pools and the like. The collecting means being preferably filled with a fluid which is water but may include antifreeze or other admixture material to the water. Alternatively oil or some other fluid may be used as the transport medium of the collector means as desired. We have shown the collector means discharging the fluid which has been heated within them into a thermo means (insulated tank means for containing hot fluid) and the exchanger means off-taking fluid from the thermo tank means but this is not entirely necessary in that there may in an alternative arrangement be that the collector means is in direct fluid connection to the exchanger means. Also it can be seen that we have chosen to site the tower upon the crest of a hill so that the fluid heated in the collector means which are down slope of the tower can rise by convection means into the thermo tank means but this is only a preferment as it is possible that the fluid within the collector means is motivated along the circuit of the collector means and into the thermo tank means by pump machine means or at least assisted along the circuit of the collector means by pump machine means. Also the exchanger means fluid flow is shown operating by convection means but this is only a preferment as it is likely in many circumstances that the fluid is driven or at least partly driven along the circuit of the exchanger means by pump machines means. In an alternative arrangement the collector means circuit and the exchanger means circuit can be in direct fluid connection and pump machine means may drive or at least assist in the driving of the fluid around the circuit of the combined circuit of the collector means and the exchanger means. It is of course likely that the same tower could be erected on flat ground or even in a hollow if desired but it is preferred that the tower is sited atop a hill or mountain or other elevated position relative to the circuit of the collecting means. In a slightly alternative arrangement to that which is shown the collector means may be located under or above a roof or be formed from hollow members of a roof. It is envisage that the collector means include photovoltaic cell means for converting at least a part of the sunlight striking the collector means directly into electrical energy accordingly the invention may include collector means which include photovoltaic cell means for the direct conversion of at least a portion of the sunlight striking it into electrical energy. In another alternative arrangement to that which is shown the collector means or at least one collector means of the system can be heated by means other than sunlight or diffuse heat from the environment. Other heat sources may be utilised as available or desired as there are a large number of potential heat sources which may be utilised, accordingly the invention is not limited to only collecting heat from the sun or diffuse heat in the atmosphere but can be adapted to source its heat from any suitable heat source including but not limited to a fire or other chemical reaction producing heat or from hot rock or lava or composting decomposing matter which is developing heat in the process of decay. It is likely that the updraft tower be formed of a number of tubes joined end on end and accordingly the invention may include tube means which are formed as separate components which are then joined together to form the updraft tower of the engine.

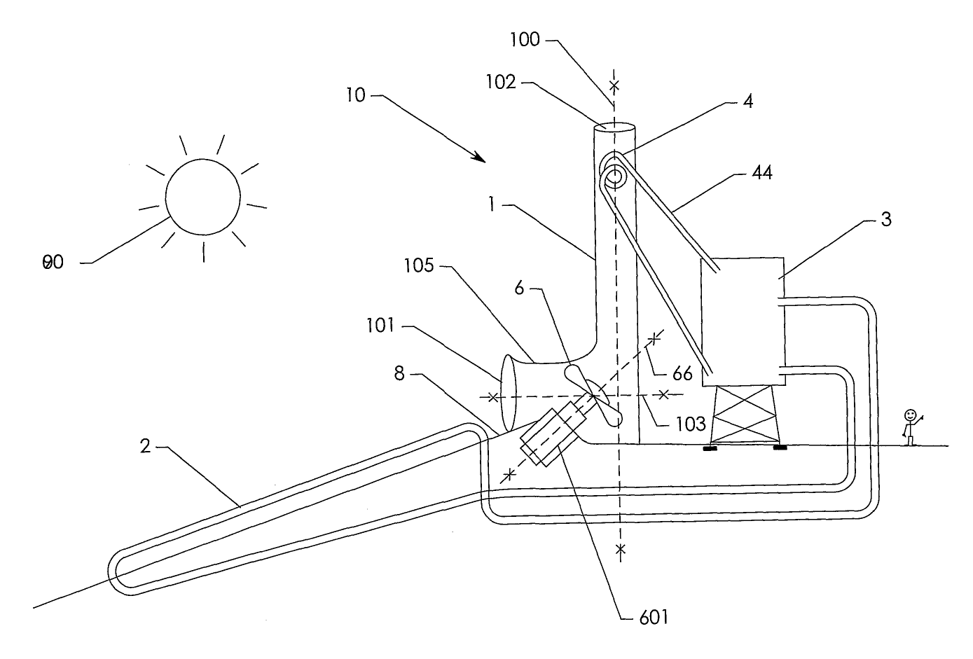

FIG. 2 is a sectional schematic side view of a embodiment of the invention formed as an engine 10 being a thermal uplift tower 1 being a hollow tube elongate along an axis 100 and having inlet orifice means 101 and outlet orifice means 102. The tower including an elbow in its lower end having a tract extension 105 extending along an axis 103 transverse to the long axis of the tower 100. The engine 10 further including collector means 2 and thermo tank means 3 and heat exchanger means 4 connected in a piped fluid flow circuit 44. It can be seen that the exchanger means 4 is located within the updraft tract 1 such that the air in the updraft tract can be heated by contact with the exchanger means and from heat radiating from the exchanger means. The engine is shown having turbine means 6 located within the updraft tower and sharing the same axis of rotation 66 as the generator means 601 such that air passing through the inlet orifice can strike against the blades of the turbine means and thus cause the turbine means to revolve around its axis of rotation 66. The turbine means is shown directly coupled to generating means 601. The collector means adapted to collect heat discharged from the sun 900. the inlet orifice being situated at the end of the lower portion 105 of the elbow of the tower 1. It is to be noted that the engine has a inlet tract extending from an elbow of the updraft tract as a preferment and there may be no need in many circumstances for there to be an elbow and transverse extension accordingly the invention is not limited to having an elbow and transverse extension as it may be configured such that the updraft tract is simply a tube extending generally upwards with the turbine means preferably aligned along or parallel to the long axis 100 of the updraft tract.

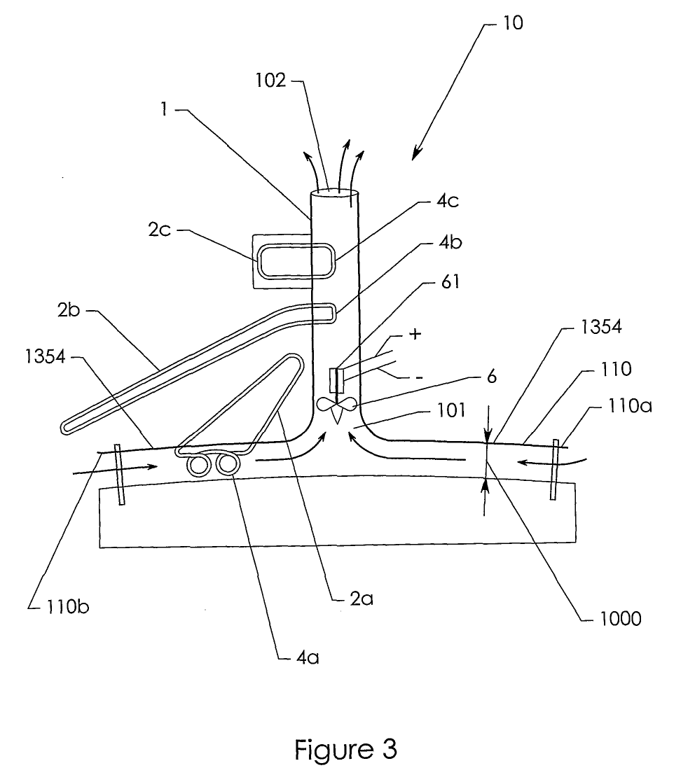

FIG. 3 is a sectional schematic side view of a embodiment the engine 10 of the invention having an updraft tower 1 being a hollow tube and having an inlet orifice means 101 and an outlet orifice means 102. Located in the updraft tower is a turbine means 6 in the path of the flow of air in the tower. The turbine means being located in the lower end of the tower (updraft tract) and being directly coupled to generating means 601. The turbine means having an axle shaft on which is mounted generator means for the production of electricity from the spin of the turbine when said turbine is spinning. It can be seen that the turbine means is located within the updraft tract such that it is located in the inlet orifice 101 portion of the updraft tract and that air passing into the updraft tract through the turbine means 6 will cause the turbine means to spin on its axis of rotation 66 (not shown) by aerodynamic principles. It can be seen the engine includes more than one collector means and that said collector means are each in a fluid circuit which fluidly connects each respective collector means to the exchanger means which are placed in the updraft tract or under the roof 110. The being three collector means 2a, 2b and 2c and each being a complete loop fluid circuit with a respective exchanger means 4a, 4b and 4c. In effect each respective collector means and exchanger means set are a loop of piping which has the collector portion located outside the updraft tract and a portion being the exchanger means located within the updraft tract or under the roof. Each of the said loops is shown adapted to pass through the side wall of the updraft tract or roof As an alternative to the arrangement shown the fluid loop circuit of at least one collector-exchanger means set does not pass through the side wall of the tower but may enter and or exit the inside of the updraft tract by one or other or both of the orifices of the updraft tract (inlet, outlet). The updraft tower (tract) being a part of a roof system 110 under which is a volume which is heated by the rays of the sun. The roof system being such that it allows sunlight to pass through its cladding and having side edges 110a and 110b in a position of elevation 1000 relative to the ground and the side edge, air being drawn under the roof by means of the suction caused by the rise of air up the updraft tract of the tower. The collector means 2a being located outside the updraft tract and roof system and being in fluid connection to exchanger 4a which exchanges heat captured by collector 2a into the air under the roof structure. The collector means 2b and 2c being located outside the updraft tract and being in fluid connection with exchanger means inside the updraft tract to impart heat collected in the collector means into the air in the updraft tract. The turbine means 6 is shown in direct connection to generating means 61 but alternatively the turbine means may be connected to the generating means by a gear train or by belt or chain means or any other suitable connection or interconnection means including but not limited to hydraulic means or magnetic means. The generator means is preferably a producer of electric current but it may be that the turbine means drives a hydraulic pump means which then drives a hydraulic engine coupled to the generating means or even that the turbine means drives a hydraulic pump and the hydraulic fluid under pressure from the driving of it is used for a industrial purpose. Arrows depict directions of air flow. NB: hydraulic solution may be incorporated into any of the embodiments of the invention contained herein

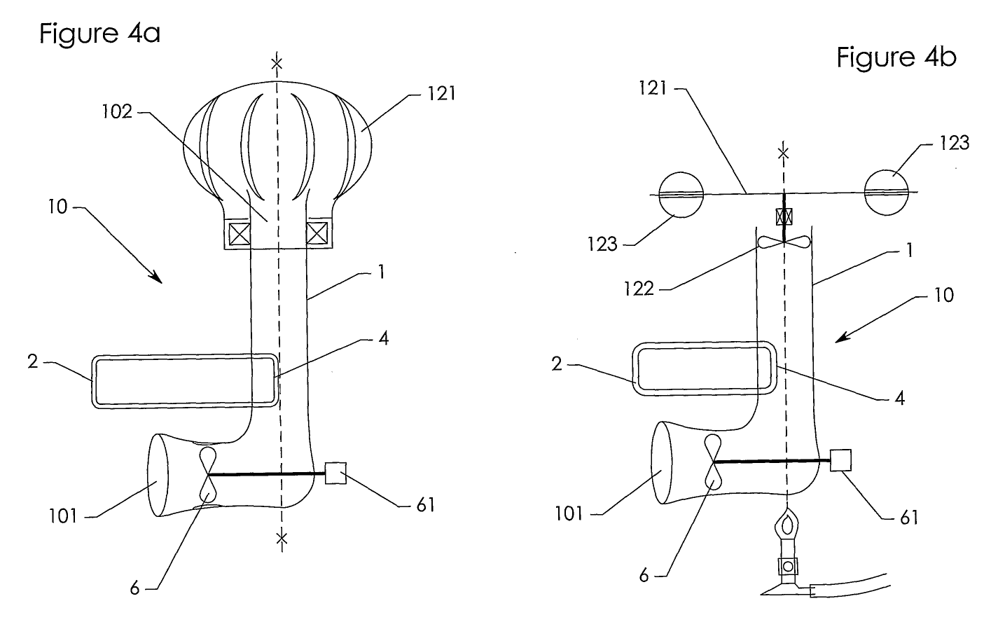

FIG. 4a shows a sectional schematic side view of a embodiment of the invention as an engine 10 in the form of updraft tower 1 being a hollow tubelike structure having inlet orifice means 101 and outlet orifice means 102. The engine further including a collector means 2 in fluid connection to exchanger means 4 wherein the collector portion is located outside the tower and the exchanger portion is located inside the tower such it is contactable by the air adjacent it in the updraft flue (tract). Exhaust fan means 121 is included at the outlet orifice end (upper end) of the tower which is provided to help lift the contents of the updraft tract out of the tower into the atmosphere. The exhaust fan means is driven by wind passing by the tower such the exhaust fan means spins on an axis. And preferably as shown the fan axis is aligned parallel to the long axis of the tower 100. The exhaust fan means in this particular instance being of a type which has vanes which are both driven by the passing wind and which also serve to pump air out of the updraft tract. The axis of rotation of the exhaust fan means being parallel to the long axis of the tower but can be at any suitable angle relative to the long axis of the tower. The engine including collector means 2 in fluid connection to exchanger means 4. The collector means for capturing heat from a location outside the tower and the exchanger means for exchanging the heat collected by the collector means into the contents of the updraft tract such that the air (contents) is heated and expands so it rises in the updraft tract in the direction of the outlet orifice. The collector means being adapted to collect heat from the sun and the environment which has be heated from the sun.

FIG. 4b shows a sectional schematic side view of a embodiment of the engine 10 of the invention having updraft tower 1 being a hollow tubelike structure having inlet orifice means 101 and outlet orifice means 102. The engine further including a collector means 2 in fluid connection to heat exchanger means 4 wherein the collector portion is located outside the updraft tract and the exchanger portion is located inside the updraft tract such it is contactable by the air adjacent it in the updraft flue (tract) of tower. Exhaust fan means 121 is included at or in the outlet orifice end of the tower which is provided to help lift the contents of the updraft tract out of the tower into the atmosphere. The exhaust fan means is driven by wind passing by the tower such the exhaust fan means spins on an axis. The exhaust fan means in this particular instance being of a type which has vanes 123 which are driven by the passing wind and which also has vanes 122 which serve to pump air out of the tower (updraft tract). The axis of rotation of the exhaust fan means being shown parallel to the long axis of the tower but can be at any suitable angle relative to the long axis of the tower as desired or practicable. The engine including collector means 2 in fluid connection to exchanger means 4. The collector means for capturing heat from a location outside the tower and the exchanger means for exchanging the heat collected by the collector means into the contents of the updraft tract such that the air (contents) is heated and expands so it rises in the updraft tract in the direction of the outlet orifice. The collector means being adapted to collect heat from the sun and the environment which has be heated from the sun.

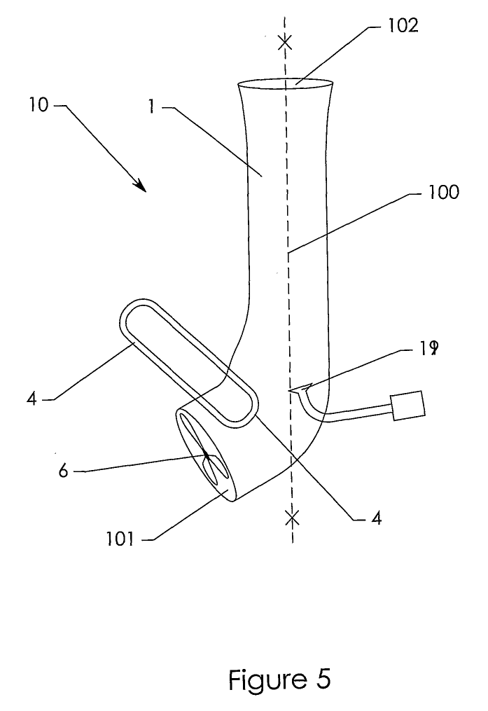

FIG. 5 shows a sectional schematic side view of a embodiment of the engine 10 of the invention which includes an updraft tract 1 having inlet orifice means 101 and outlet orifice means 102. The engine including collector means 2 in fluid connection with exchanger means 4 and the engine further including steam piston injection means 191 adapted to inject intermittently shots of steam into the air in the tower 1 and the shots of steam being like pistons which push the air above them along the tract and which suck the air below them along the updraft tract.

FIG. 6 shows a sectional schematic side view of a embodiment of the engine 10 of the invention which includes an updraft tower 1 having a lower end having inlet orifice means 101 and outlet orifice means 102 at its upper end, turbine means 6 for extracting work from air flow in the updraft tract and adapted to drive generating means 61, the inlet orifice opening into a volume located under a roof which is suspended above the ground, the engine further including a first solar collector means 2a fluid connected to or fluid connected to a surface of first exchanger means 4a located in a location within the updraft tract 1 or wall of the updraft tract 333 by pipe means from the collector means or intermediate container there between such that heat collected from a distant location outside the tower may be transported by fluid means between the first collector means and the first exchanger means and from there into the air proximate the first exchanger means 4a in the updraft tract 1, the engine further including second collector means located not within the tower or under the roof and the second collector means connected/linked to second exchanger means 4b located within the updraft tract 1 for heating air proximate it in the updraft tract, the second collector means adapted to collect heat from the suns rays and diffuse heat from the environment and there being fluid piping means along which fluid can flow to transport the heat collected to the second exchanger means 2b, the engine further including third collector means 2c located below the roof 1354 in fluid connection to third exchanger means 4c located within the updraft tract for exchanging heat into air adjacent said third exchanger means 4c within the updraft tract. The air under the roof has heat added to it by radiation from the roof and by coming into contact with heated members of the roof. The first collector means is able to gather heat from a distant location from the tower and the heat is then transported along pipe means in a fluid medium to the first exchanger means which is located in a first location along the length of the tower being a location above the turbine means 6 to cause the air at that location to be heated up by radiant heat and by contact with the exchanger surfaces of the first exchanger means. The second collector means collects heat from a location outside the tower and is connected by fluid piping means to the second exchanger means which is located in the updraft tract in a location above the turbine means to heat the air proximate it in the updraft tract to cause the air to expand and rise within the updraft tract. The roof structure being a zero height roof tensioned between stay means. The passage of the air being through the inlet orifice means 101 passing through the turbine means 6 and past the first, second and third exchanger means in a direction along the long axis of the updraft tract and then out the outlet orifice 102 of the tower. The passage of the air through past the turbine means driving the turbine means around its axis to extract work from the air in the passing. We have found that we can heat the air in the air column in the tower by way of heat exchanger system. We use solar or heat collecting system and pipe fluid being the transport medium from the collector means to heat exchanger element means located within the air column so that air in the air column is energised and expands and rises up the air column which is an improvement over what would be the case if the updraft tower were fed by heated air as is known in the prior art which relies only on air heated under a roof structure to provide the heat in the working fluid (gas) moving along the updraft tract. Our discovery that heat exchanger means located in the air column of the tower for delivering heat to the air already in the updraft tract substantially increases out put of a given tower over that shown in the prior art. The new system of the invention may include one or more exchanger means located within the air column of the updraft tract. We have chosen to show in this figure a variety of locations where collector means may be sited relative to the roof structure and the tower and all can be deployed if desired.

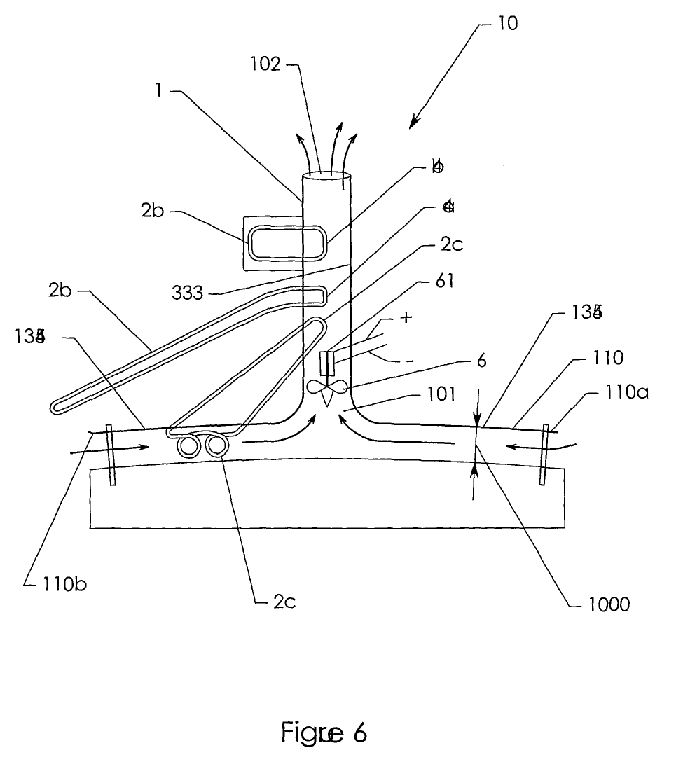

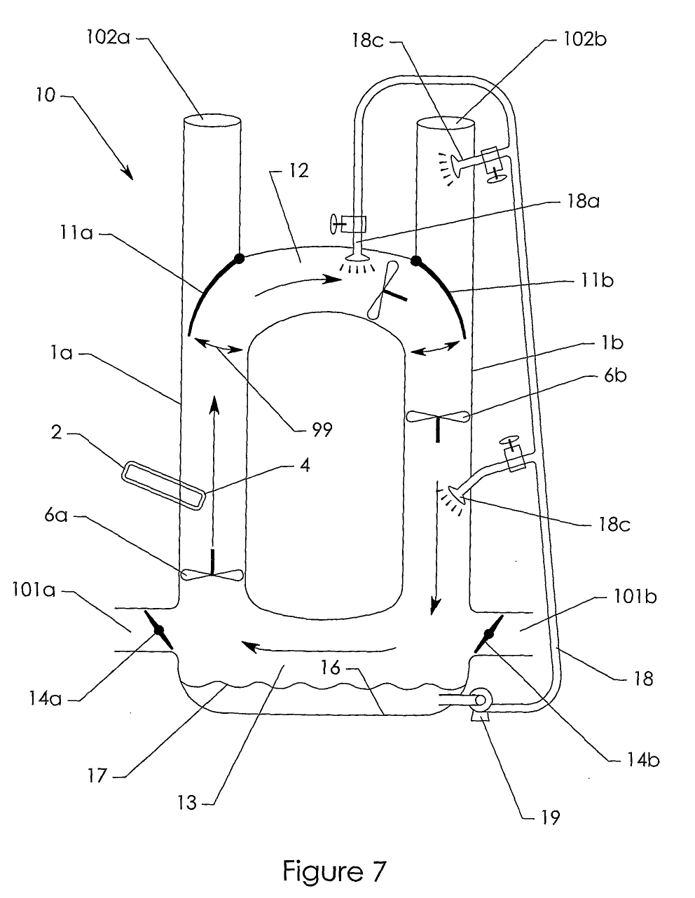

FIG. 7 shows a sectional schematic side view of a embodiment of the invention wherein there is provided two updraft towers 1a and 1b. The embodiment being a multi purpose engine of the invention which can be switched from operating as an updraft only version of the invention into an updraft and downdraft version of the invention or even into a closed loop version of the invention. The gas flow of the engine in loop form is clockwise. The engine structure being such that there is included a upper cross over tract 12 which includes door/gate means 11a and 11b which may be selectively operated to cause the airflow passing up an updraft tract 1a to bypass its respective the outlet orifice 101a and travel along the upper crossover tract 12 into the other of the updraft tract lb so it can fall down the updraft tract 1b and the engine construction being such that a lower crossover tract 13 is provided to link the bottom end of each of the updraft tracts 1a and 1b together so that air may pass between them. Basically the embodiment shows a loop version of the invention which would normally have air circulating around it in one direction but which can be operated such that it functions as an updraft version of the invention or an updraft and downdraft version of the invention. The inlet orifices 101a and 101b needed to provide this modality having butterfly gate means 14a and 14b which can be selectively operated to close the bottom end of the engine off from the atmosphere into a loop at will and the upper ends of the updraft tracts having gate means 11a and 11b which can be selectively operated to close the top end of the updraft tracts off from the atmosphere such that the air in the engine must travel around the loop created by the selective use of the gate means of the invention. Depending on which passage the gate means of the invention are caused to close or open the engine can be forced to operate in a number of different ways eg as updraft only version of the invention, as updraft and downdraft version of the invention and as a endless flow loop version of the invention. The engine including collector means 2 and exchanger means 4 to convey and introduce heat into one or other of the updraft tracts to provide the energy to the air in the engine so it expends and rises in at least one of the updraft tracts as desired. The engine is also provided with chilling water supply piping system 18 which includes pressure pump means 19 pressurising and supplying chill fluid spray injection means 18a, 18b to cool the risen air which has moved into the upper cross over tract or updraft tract which is converted into a downdraft tract in versions of the invention which have the engine operating as a updraft tract and downdraft tract engine or as a endless loop version of the invention. The chill water 17 may be stored in the tower structure in a cistern means 16 located at the floor of the lower crossover tract 13. The chill water injection means being adapted to inject chill water into the air stream of the upper crossover portion of the engine selectively as required in modalities of engine operation wherein the air does not just pass up an updraft tract and then out into the atmosphere but at least descends again in one of the updraft tracts which has been converted into a downdraft tract by the selective use of gate means in the tracts of the engine. There is provided in the updraft tracts turbine means 6a, 6b respectively which can extract work from the passage of the air through or by them. Preferably at least one of the turbine means 6a or 6b is bi-directional in that it can extract work from the passage of gas through it when the air is travelling up the updraft tract 1a and when it is passing down the updraft tract lb depending upon the selective opening or closing of the gate means of the engine. It is preferable that the collector means 2 is a solar thermal fluid heating system which includes a loop of piping or tube means which is heated by the sun and which is in fluid connection with exchanger means 4 in at least one of the updraft tracts.

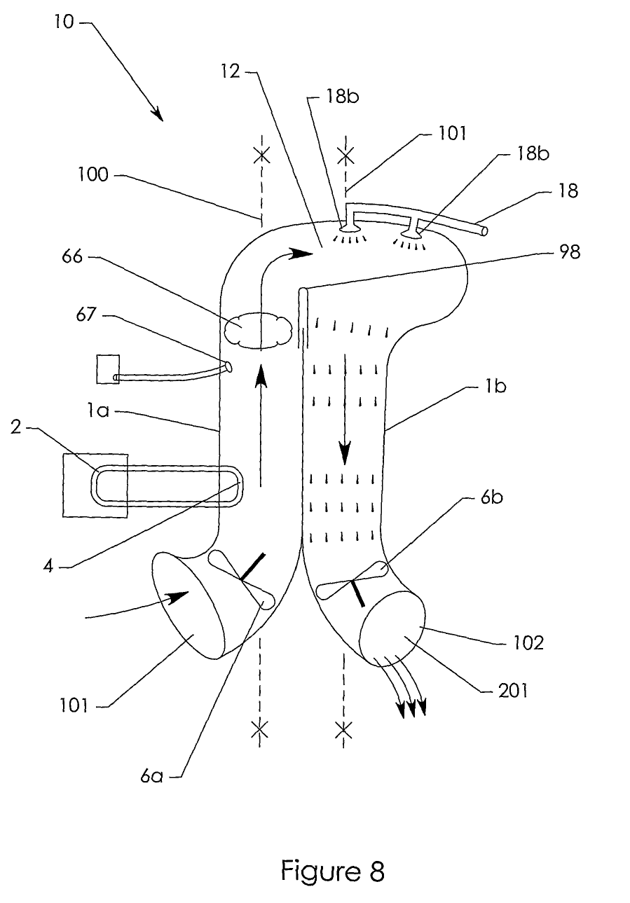

FIG. 8 shows a sectional schematic side view of an embodiment of an engine of the invention which includes an updraft tract la and a down draft tract 1b closely siamesed to each other and connected to each other by a upper cross over tract 12 such that the upper end of the updraft tract and the upper end of the downdraft tract are connected allowing air flowing up the updraft tract to flow through to the upper end of the down draft tract (when we say upper end in this specification we mean that end closer to the sky than the lower end which is further away from the sky than the upper end, in other words what one would normally mean upper and lower to be relative to each other and to a man standing upright on the ground) where it can then commence to flow down the downdraft tract. The updraft tract is fitted with exchanger means 4 which are used to impart heat energy into the air stream of the updraft tract and the exchanger means is connected to collector means 2 which absorbs heat energy from a heat source which is ideally the suns rays. The cross over portion 12 being an expansion chamber and portion of the downdraft tract such that the air which has risen up the updraft tract can be rapidly expanded and cooled so that it becomes dense enough to commence to fall down the downdraft tract and if required chill fluid may be injected and entrained into the air ion the expansion chamber so as to further cool it and increase the speed of its fall down the downdraft tract. It may be necessary to chill the air in the expansion chamber with chill spray introduction means 18a, 18b before it begins to fall down the downdraft tract depending of the heat it was heated to by the exchanger means 4 in the updraft tract in some circumstances. The injection of chill water may be such that it is intermittent or that it is constant or that it is variable to match the condition of the air in the expansion chamber with regards to the heat it still holds whilst in the expansion chamber 12. This embodiment shows that the crossover point wall 98 is variable in height relative to the bottom of the updraft tract and the bottom of the downdraft tract and the height being adjustable by adjustment means (not shown) which may be a hydraulic ram of threaded adjustor means or any other means with which to adjust its height such that the crossover point surface is moveable inline with the long axis of the siamesed updraft and downdraft tracts of the invention. Furthermore the engine is adapted to include steam injection means 97 which can inject shots of steam 66 into the ascending air column as desired. The addition of steam into the air in the updraft tract adding heat to the air in the updraft tract it comes in contact with and the steam being lighter than air moves up and along the updraft tract until it reaches the crossover expansion chamber 12 wherein on expansion in said expansion chamber it collapses into water droplets and falls down the down draft tract and as it does carrying and pushing air in the downdraft tract down the downdraft tract towards the bottom of the downdraft tract and through the turbine means 6b and then out through the outlet orifice 201 of the downdraft tract. The updraft tract and the downdraft tract may of the same length as each other or be of unequal lengths relative to each other as desired and this holds for all the various embodiments of the invention.

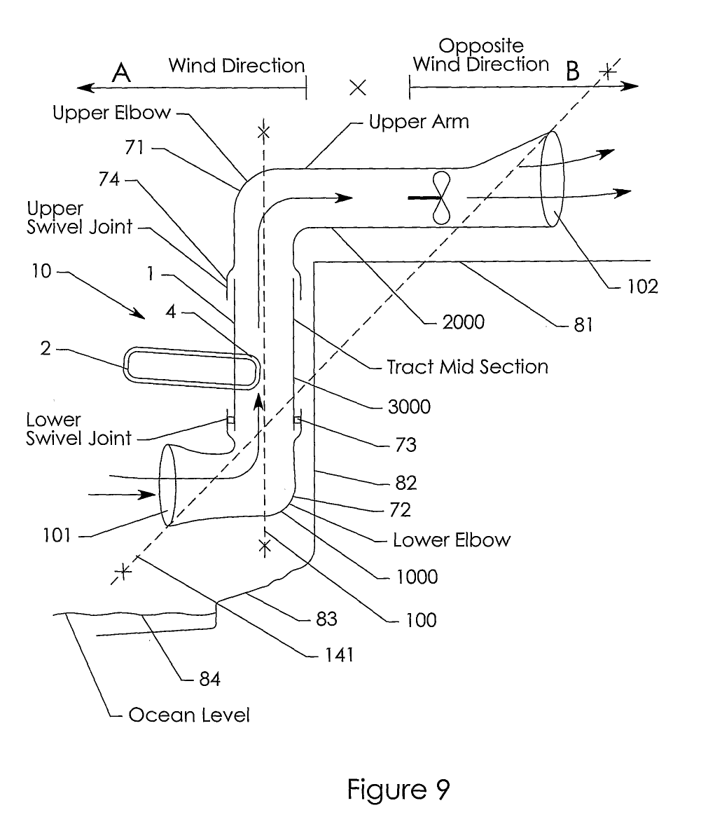

FIG. 9 shows a sectional schematic side view of an embodiment of the invention which is in the form of an updraft tract 1 engine overlaying a cliff 82 such that the inlet orifice of the tract 1 is located at or around the cliff base 83 and a outlet orifice means 102 is located above the level of the top 81 of the cliff Included into the updraft tract are exchanger means 4 or energising with heat air passing by the exchanger means up the updraft tract 1 causing the air heated by it to rise in the updraft tract by making it expand and become lighter. Ideally the engine is sited along the Great Australian Bite where there is a fairly constant air flow from south to north or from south west to north east. The air at the bottom 83 of the cliff being pressurised by the air trapped by the cliff and stacked on top of it. The updraft tract having its inlet orifice at or near the bottom of the cliff allowing air at the base to flow into the inlet orifice under pressure and then forced up the tract 1 and out the outlet orifice. The tract being extended in its upper length in line with the wind direction and the outlet orifice facing away from the wind direction to allow for the air passing through it to enter the atmosphere travelling in the same direction as the wind is travelling. The wind so passing the outlet orifice causing suction of the outlet orifice and helping to pull air out of the tract in doing so. The system can be operated in reverse such that wind passing from north to south or from the north east to the south west can be forced into the outlet orifice 102 and down the tract 1 to be expelled out the inlet orifice 101 at or near the cliff bottom 83. The tract 1 including turbine means 6 adapted to extract work from the passage of air in either direction along the tract 1 as desired and as the wind conditions allow. The upper end 1000 of the tract can be swivel mounted to the mid portion 3000 of the tract structure so it can be aligned with the wind flow to increase the suction of the outlet orifice 102 end or to increase the pressure at the inlet orifice 101 end as desired and allowed by wind direction. This embodiment of the invention may operate without need of exchanger 4 collector means 2 in certain circumstance however it is preferred that in all circumstances heat is added to the air in the tract by exchanger means 4 and that the collector means be adapted to use a heat source namely the sun rays. Preferably the axis of swivel is aligned perpendicular to the horizon although any suitable angle relative to the horizon may be adopted if practicable and if desired. When wind is blowing towards the outlet orifice end located above the top level 83 of the cliff 82 there is a partial vacuum at the cliff base which helps to draw air out of the inlet orifice located at the cliff base or near thereto. When we say at the cliff base or close thereto we mean at a distance between the cliff base and the cliff top. The outlet orifice located above the cliff top may be located at the end of an extension 2000 of the of the tract which lays along or inline with the surface of the ground at the cliff top or it may be that the tract extends a distance above the ground at the cliff top and then an elbow extension extending which is swivel mounted preferably so that it can align itself with the wind direction and the air passing out the orifice can be in the direction of the wind flow. The system shown in this embodiment may be used in conjunction with any cliff anywhere in the world suitable. It is preferred that the ends of the tract 101, 102 are trumpet shaped. Chill water may be added to the air flow in the tract 1 when the device is operating such the air flowing from a point above the top of the cliff to below the cliff top and thermal energy may be added to the air when it is passing from the cliff base to a location above the cliff top by exchanger means 4. Venturi means may be incorporated into the tract to increase the air speed flowing through the turbine means 6. It can be seen in this ideal embodiment of this embodiment that the tract 1 is doglegged in shape having a first elbow 72 at the cliff bottom and a second elbow 71 at the cliff top 83. The top 2000 and the bottom extensions 1000 from the elbow may be swivel mounted to the mid portion 1000 of the tract 1 to allow them to be electively aligned for the prevailing wind conditions, as desired. This same device could be mounted onto a mountain to the same effect with the inlet orifice 101 located at a down slope location of the mountain and the outlet orifice 102 end located above the mountain. In fact the tract 1 could be adapted to pass through a portion of a mountain. And so it could with a cliff 82 as well in that it may not be needed that the tract overly the cliff face but can be adapted to pass through a portion of the cliff face if desired and a path is shown it may take 141 through cliff face if desired (but any other useful path will do. Chill water may be sourced from any convenient location as desired but if the engine is located along a coastline it is preferred that the source is the ocean. The same can be said if the engine is sited near a lake or other water body

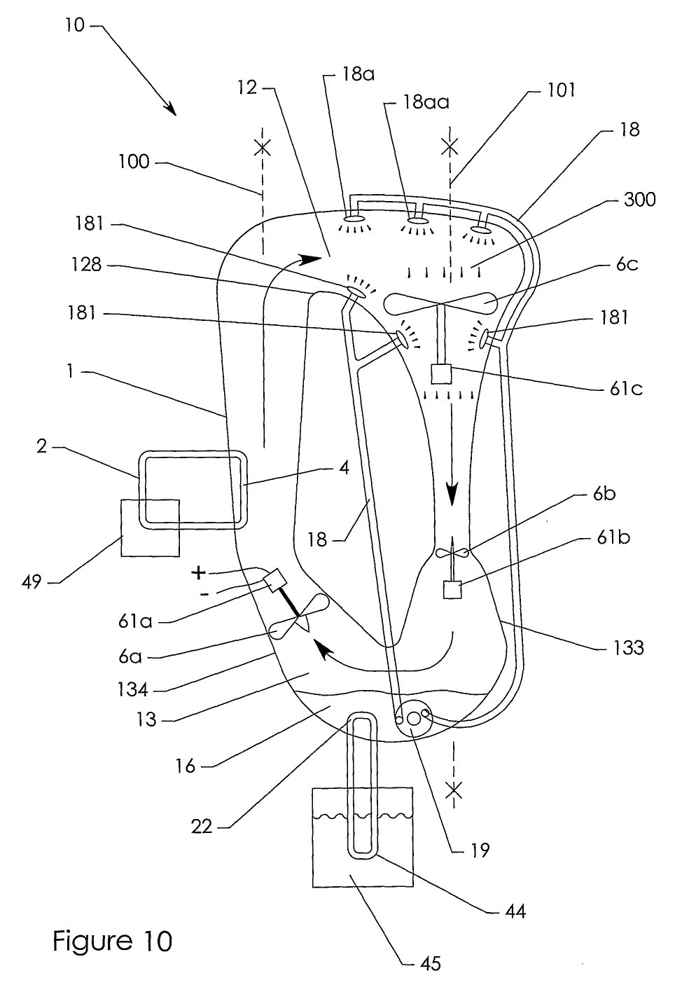

FIG. 10 shows an embodiment of the invention which is in the form of a endless loop engine 10 having an updraft tract 1 and a down draft tract 21 which are connected together at their respective top and bottom ends by cross over tract means, a upper cross over tract means 12 to link the top ends together and a bottom crossover tract means 13 to link their respective bottom end together. The engine including a upper expansion chamber 300 at the top end of the downdraft tract for the expansion of air which has passed up the updraft tract and through the upper crossover tract into the down draft tract portion of the loop. The upper expansion chamber 300 allowing the air which has made its way to it to rapidly expand and thereby lose its heat in the work of expansion and thereby grow in weight such that it begins to fall down the downdraft tract portion of the loop. The engine being equipped with chill fluid introduction means 18 having chill fluid injection nozzle means 18a. 18aa. 18aaa, which entrains chill fluid into the air in the upper expansion chamber further taking heat from the air causing it to further cool and become dense in order that it will fall down the downdraft portion 21 of the loop or be at least far easier to draw down the downdraft portion of the loop. Preferably the chill fluid is water but any useful safe for the purpose fluid can be used. The lower crossover tract portion 13 includes a cistern portion 16 for collecting chill fluid spent in the cooling of air in the upper expansion chamber and down the downdraft tract 21. There is provided chill fluid introduction means 181 at intervals along the length of the downdraft tract and these may be selectively operated as desired to reduced the temperature of the air passing along the downdraft tract as it passes each of the introduction means. The cistern is connected to heat collector 22 exchanger means 44 to allow the fluid in the cistern 16 to be cooled after it has been spent and collected in the cistern portion. The exchanger means 44 being able to dump heat it holds into a cooling source 45. In other words the chill fluid which has been introduced into the air stream in the system takes up heat from the air in the system it comes into contact with and may need in some circumstances to be cooled in order that it be usefully cool enough for the purpose of chilling air in the upper expansion chamber and downdraft tract portions of the loop. The downdraft tract is shown tapering down from its biggest to cross sectional area perpendicular to the long axis 101 of the downdraft tract located at the upper end of the downdraft tract to its narrowest cross sectional area perpendicular to the downdraft tract long axis towards the bottom end of the downdraft tract where there is located a turbine means 6b for extracting work from the air which is falling down the downdraft tract. The turbine means 6b located in the bottom end of the downdraft tract sits above the lower crossover tract 13 and directly below the said turbine means 6b the cross sectional area of the lower crossover tract is larger than that cross sectional area of the downdraft tract immediately above said turbine means 6b such that lower cross over tract includes a expansion chamber 133 and that the air that passes through said turbine means 6b in the bottom end of the downdraft tract can be expanded rapidly to take heat from it. The lower end of the updraft tract is equipped with a turbine means 6a for extracting work from the air which is drawn through it as it passes up the updraft tract 1 from where it was in the lower crossover tract on its way to the upper crossover tract. Immediately before the turbine means 6a is a compression chamber portion of the lower crossover tract which is a tapering towards the turbine means 6a such that as the lower crossover tract walls approach the turbine means 6a it narrows. Above the turbine means 6a is located a exchanger means 4 with which to impart heat captured by collector means 2 outside the tower into the updraft tract. The collector means 2 being a solar collector means 49 of fluid flow type akin to that which is used to heat water in houses and swimming pools. The collector means 2 may be in combination with photovoltaic cell means (not shown) such that a greater portion of the energy provided from the sun is harnessed to good use. The engine further including turbine means 6c located at or around the top of the downdraft tract to extract work from the air falling out of the upper expansion chamber down the downdraft tract. The turbines 6a, 6b, 6c of the engine each driving a respective generator means 61a, 61b, 61c to produce electricity. However it is to be noted that the engines of the invention may be used to produce hydraulic pressure as well as or in replacement for electrical energy if the generator means is a hydraulic pump means. Preferably each of the generator means spins on the same axis as does the respective turbine means spins on but this need not be so in many instances as the turbine means shaft may engage by gear means with a shaft of the generator means which is offset from the axle of the turbine means, or there may be a gear train or chain or belt drive system utilised to join a respective turbine means to a generator means of the engine, this is generally so with any of the various embodiments of the engine contained herein. Turbine means 6b and turbine means 6c may be mounted on the same axle shaft if preferred and if so turbine means 6c is preferably greater volumetric throughput than turbine means 6b.

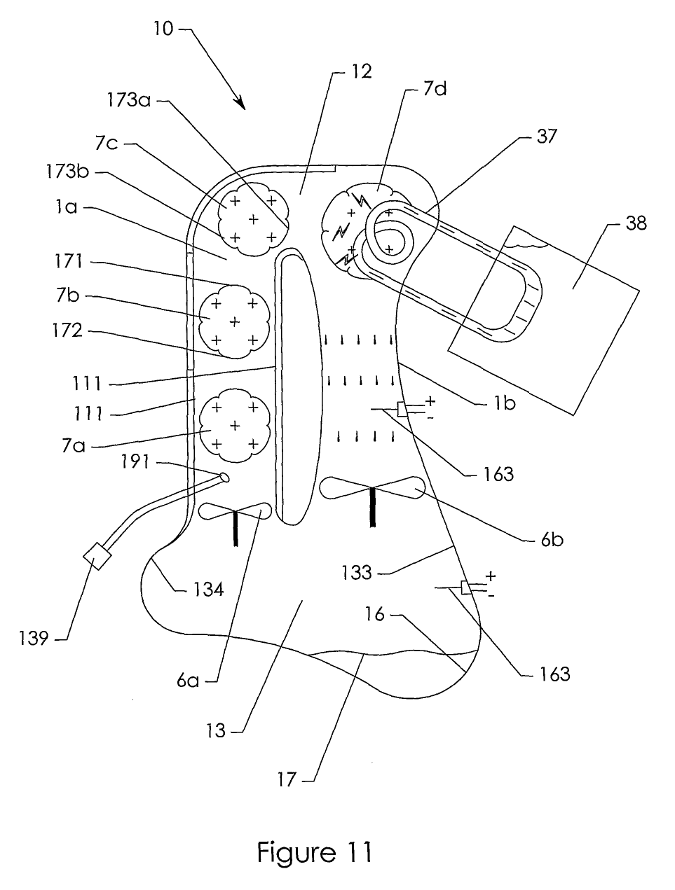

FIG. 11 shows a sectional schematic side view of a embodiment of the invention in the form of a endless loop engine 10 which utilizes cloud pistons 7a, 7b, 7c, 7d which are injected by steam piston injection means 191 at intermittently into the updraft tract 1 portion of the loop. Each of the pistons having a crown 171 and a crown underside 172 and having side wall/s 173a, 173b. The loop 10 including updraft tract means 1 and down draft tract means 21 and having a upper cross over tract 12 portion and a lower cross over tract 13 portion. The upper cross over tract portion joining the upper end of the updraft tract to the upper end of the downdraft tract and the lower crossover portion joining the lower end of the downdraft tract to the lower end of the updraft tract. The updraft tract and the downdraft each having respective turbine means 6a, 6b and generator means 61a, 61b stationed within them for extracting work from the passage of air through them as the air makes its way around the loop 10. The air is shown circulating around the loop in a clockwise direction. The updraft tract including exchanger means 4 to impart heat energy into the air passing it by up the updraft tract and the downdraft tract portion including heat collector means 22 to take heat from the air passing it in the downdraft tract. The exchanger means 4 situated in the updraft tract being located above the turbine means 6a in the updraft tract (but it can be located under the turbine means in the updraft tract if desired it being a preferment that it be located above the turbine means). The downdraft tract including turbine means 6b at a location along the length of the downdraft tract such that the location is at the bottom end or near the bottom end of the downdraft tract. Collector means 22 in the updraft tract collecting heat from the air stream in the expansion chamber 12 of the upper end of the downdraft tract and by means of fluid connection the heat is transported to expansion means 44 located in a cooling medium wherein the heat collected from the upper expansion chamber by the collector means 22 can be dumped. Collector means in the upper end of the downdraft tract (expansion chamber portion of same) The engine being configured to have steam piston injection means 191 intermittently injecting a shot of steam or shots of steam to form cloud pistons 7a, 7b, 7c, 7d into the airstream in the updraft tact above the level of the turbine means 6a in the updraft tract. The steam within the pistons being electrically charged (dry or wet steam as desired) and the wall/s 111 of the s updraft tract being electrically insulated such it has no charge or being insulated from the ground but electrically charged the same polarity as that the steam carries. When viewing the depiction we have indicated pistons 7a, 7b, 7c, 7d but to track the progress of a single piston in its motion up the updraft tract 7a may be used to indicate a first position along the updraft tract, 7b a second position along the said tract further up than that indicated at 7a, 7c a position even further up and along said tract and 7d where the piston is discharging onto collector electrode means 44. In other words showing stages of progression of the piston where it is depicted at 7a when it is created by the action injection means 191 to a final stage when it discharges at 7d onto the collector means 44. The cloud piston 7a makes its way along the updraft tract 1 until it reaches the upper cross over tract portion 12 of the loop and as it passes into the expansion chamber 12 at the top of the downdraft tract and it is the drawn towards the heat collector electrode means 44 which is in the expansion chamber because the said collector means 44 carries an opposite charge to that which the piston carries and discharges its charge onto the said collector means and in the coming of in contact with said collector means which is colder than itself and thereby losing electrical energy and heat in the process. The cloud having lost a portion of its energy condenses into water droplets which are heavier than air and so fall down the downdraft tract 21 to be collected in the bowel or cistern 16 of the lower crossover tract portion 13 of the loop 10. A form of magnetic refrigeration. The loop engine can include electrodes 163 in the down draft tract or lower crossover tract to pick up any still charged components of the cloud piston/s if required or desired. The steam used to form the piston/s may be charged by a steam charging machine 139 including but not limited to an Armstrong machine. The collector electrode apparatus 44 located in the upper crossover expansion chamber is preferably led to earth.

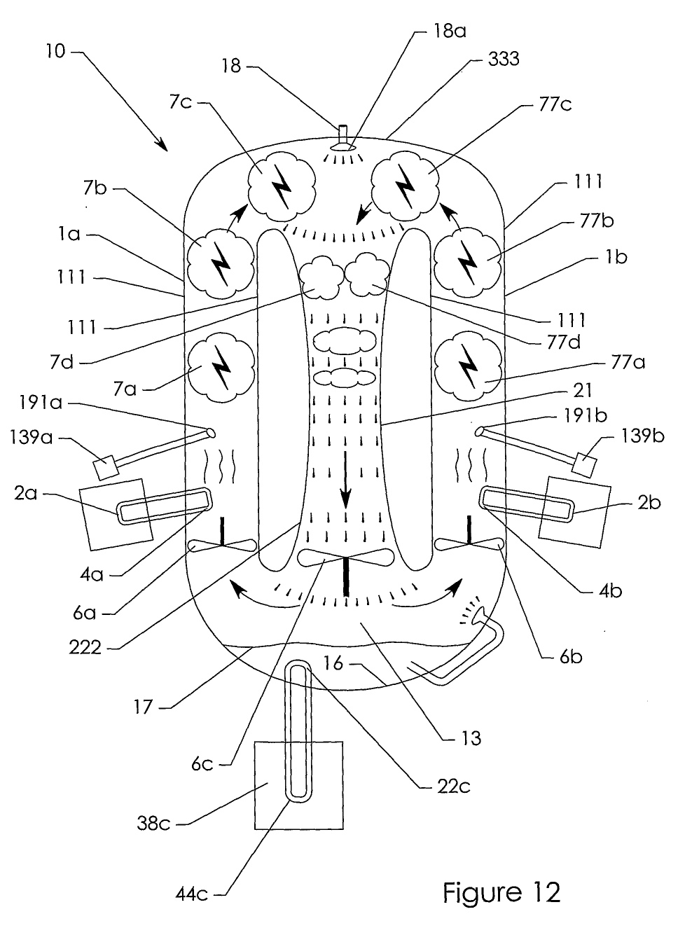

FIG. 12 shows a sectional schematic side view of the invention in the configuration of an endless loop engine 10 which includes two updraft tracts 1a, 1b and a single downdraft tract 21, the two updrafts tracts connected each at their respective upper end to the upper end of the downdraft tract by a upper crossover tract 12 and the two updraft tracts connected each at their lower end to the lower end of the downdraft tract by a lower crossover tract 13. The loop system resembling two endless loops siamesed in flow down the length of the downdraft tract 21. Each of the updraft tracts 1a, 1b including respective exchanger means 4a, 4b for imparting heat captured out side the engine by respective collector means 2a, 2b into the air streams of the updraft tracts at locations above the respective turbine means situated in their respective lower end. The downdraft tract 21 laying between the flanks of the updraft tracts 1a, 1b. The turbine means in the lower end of each updraft tract adapted to extract work from the passage of air through them as the air cycles through the loop engine and passing through them The downdraft tract including turbine means 6c at or around its lower end for extracting work from the air falling down the downdraft tract 21. Chill fluid injection means 18a being located in the upper crossover tract 12 which doubles as an expansion chamber at the top end of the updraft tracts and top end of the downdraft tract. The loop engine being adapted to use steam pistons 7a, 7b, 7c ,7d and 77a, 77b, 77c, 77d injected by respective steam piston injection means 191a, 191b above respective turbine means 6a, 6b. In the upper expansion chamber is located combined electrode and chill fluid injection means 18a for attracting the cloud pistons and for allowing the steam pistons to discharge the charge they carry into. The steam pistons being charged by steam charging means 139a, 139b and the walls 111 of the updraft tracts being electrically insulated and or being charged with a charge being the same polarity as that the steam pistons carry. The wall/s 333 of the upper crossover tract being electrically insulated or portion of same carrying the same charge as that the pistons are charged with and or having portions charged with an opposite charge than what the cloud pistons carry. The lower crossover tract including cistern means 16 to capture water condensate falling down the downdraft tract 21. One of the air motion travelling in a path in a clockwise direction and air flow travelling a path in a anti clockwise direction such the two motions coalesce in the downdraft tract 21 such they are travelling in the same direction down along the downdraft tract towards the lower cross over tract as each other with the air in tract la travelling clockwise and the air in tract 1b travelling anti-clockwise. The engine 10 being configured to run on atmospheric air but can be configured to run on any suitable gas/air including but not limited to the following examples: carbon dioxide, carbon monoxide, nitrogen, electroconductive gasses. Preferably the chill fluid is water but any suitable liquid may be used or admixture of liquid and any other suitable matter including solid matter. The chill water level 17 in the cistern being a lower wall of the lower crossover tract 13.

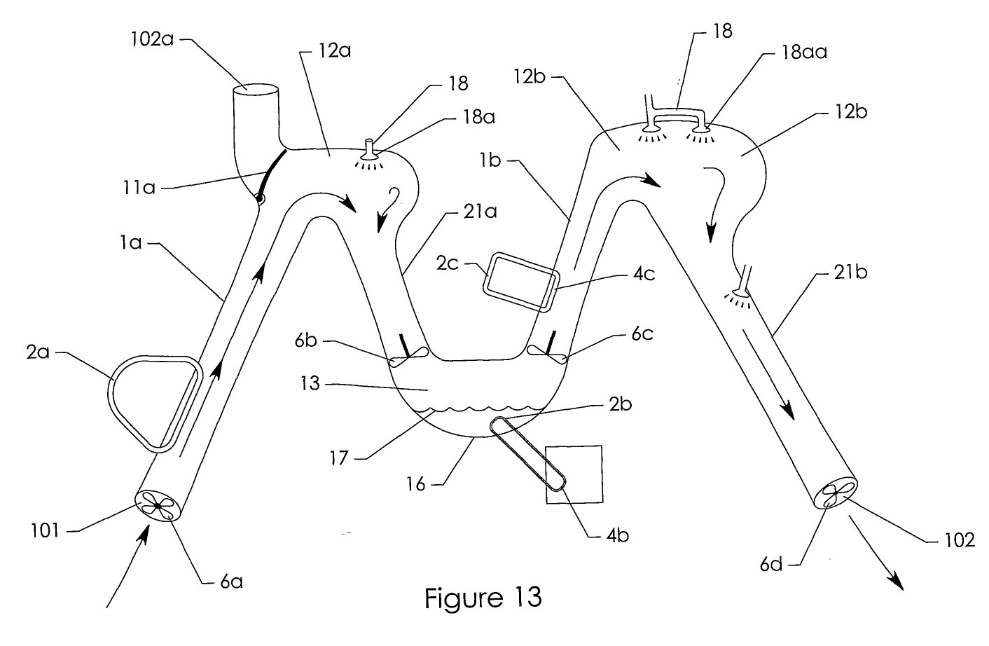

FIG. 13 shows a sectional schematic side view of the engine invention 10 having two updraft towers and two downdraft towers. A first updraft tract 1a has inlet orifice means 101 and at the upper end of said first updraft tract is a first crossover tract 12a connecting the first updraft tract to a first downdraft tract 21a which is connected at its lower end to a second updraft tract 1b by a lower crossover tract 13. The second updraft tract is connected to a second downdraft tract 21b by a second upper crossover tract 12b and the second downdraft tract at its lower end includes outlet orifice means 102. The first crossover tract 1b includes a first turbine means 6a and the first downdraft tract 21a includes a turbine means 6b. the second updraft tract includes a turbine means 6c and the second downdraft tract 21b includes a turbine means 6d. The gas flow through the engine is through the inlet orifice means 101 and then up the first updraft tract 1a, then down the first downdraft tract 21b and then up the second updraft tract 1b and then down the second downdraft tract 21b and out the outlet orifice 102. The turbine means in each tract extracting energy (work) from the passage of gas (air) through the system. Collector means coupled with exchanger means are used to heat the air in each of the updraft tracts so that the air in the updraft tracts rises in the tracts into the upper crossover tracts into which they feed. The upper crossover tracts being in the form of expansion chambers for allowing the air to expand and thereby lose its heat in the work of expansion. The upper crossover tracts including chill fluid introduction means in the form of injector means which intermittently or alternatively constantly inject chill fluid into the air travelling through them. There being a cistern arrangement at the floor or forming the floor of lower crossover tract 13. The first updraft tract being of a different total length to that of the second updraft tract such that the first updraft tract is longer than the second updraft tract. The first down draft tract being of a different total length to that of the second downdraft tract such that the first downdraft tract is shorter than the second downdraft tract. The engine further including chilling water injection means 18a and 18aa for cooling the air in the downdraft tracts of the engine. As can be seen the chilling water injection means may include one or more injection nozzles. It is preferable that more than one injection nozzle is disposed within the upper crossover tracts and/or downdraft tracts but in many circumstances only one will be needed accordingly the invention is adapted to include at least one chilling water injection nozzle means. The chilling water may also be wicked or entrained by other means other than injection nozzle means into the air flowing along the downdraft tracts or through the upper crossover tracts by wick means which can be of any useful wick shape but it is preferred that the wick means be either mat-like wall or curtain or tendrils being elongate and protruding into the air stream. The chilling water injection means may be a pressure driven system utilising power pump means as shown or it may be a gravity driven system if desired and practicable. The engine being adapted to extract energy with its turbine means in the updraft tracts and by its turbine means in its downdraft tracts, although one or other of the turbine means may be selectively turned off or taken out of service if desired. It is shown that the chilled water which has made its way down the first downdraft tract is caught by cistern means 16. The engine 10 further including outlet orifice means 102a for the first updraft tract which is adapted to be selectively opened and selectively closed as desired such that the engine may operate on only the first updraft tract mode when desired. The selective opening and selective closing of the outlet orifice of the updraft tract being performed by door means 11a which are preferably hinged and which are adapted to swing open away from the direction of flow or towards the direction of flow but any form of gate or door means may be adopted for the purpose.

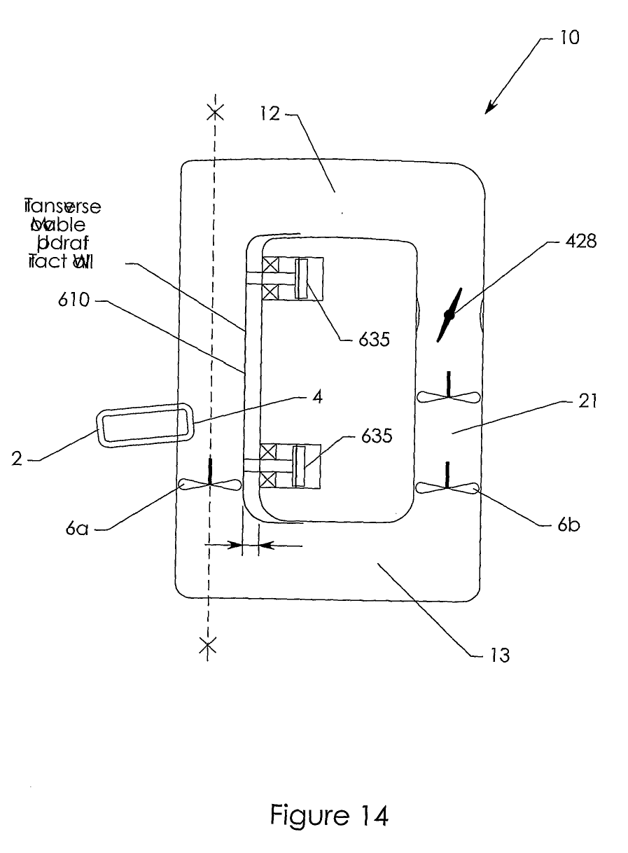

FIG. 14 shows a loop version of the engine 10 wherein are included means to adjust the cross sectional area of the tract such that the flow rate along the tract may be altered and the speed of the gas flow in the engine moderated and controlled thereby. The engine including an updraft tract 1 and a down draft tract 21 and the upper end of the up draft tract being connected to the upper end of the down draft tract by upper cross over tract means 12 and the lower end of the updraft tract and the lower end of the down draft tract being connected by lower crossover tract means 13. The updraft tract including a moveable wall 610 which may be moved selectively to adjust the flow rate within the tract such that the speed of the gas flow within the engine 10 may be moderated. The adjustment means being preferably hydraulic means 635 for moving the wall of the tract transversely relative to the long axis of the updraft tract. It is to be noted that any of the wall of any of the tracts of the engine may be also adapted for movement relative to the long axis of the tract in question as desired for the moderation of the performance of the engine with respect to speed of gas (air) movement in and around the engine. It is shown that the updraft tract in this case includes at least one wall which is adapted to be moved relative to the long axis of the updraft tract to alter the cross sectional area perpendicular to the long axis of the updraft tract. It is shown in this embodiment of the invention that valve mean may be included in at least one of the tracts of the engine to allow for the moderation or even complete stopping of gas flow in the engine. This can be adapted to all other embodiments of the invention contained herein. It is also to be noted that the butterfly valve means 428 is located within the down draft tract for the moderation of gas flow speed along the downdraft tract for the adjustment of the performance of the engine and that butterfly means may be included in any or all of the tracts of the engine. The inclusion of valve means in any tract of any embodiment of the invention is possible and therefore we hereby include such means or means like them into any and all of the embodiments of the invention as desired. At least one of the tract walls of the engine being adapted to move in a transverse direction to the long axis of the tract to alter the cross sectional area of the tract to provide governing means for the engine. Long Axis of Updraft Tract. Updraft Tract may include a Movable Wall. Loop Engine form of the invention. May include Venturi Means. May include Valve Means to adjust flow rate of air in the Tract. Means to move the wall to adjust the cross sectional area of the Updraft Tract Cross Sectional perpendicular to the Long Axis of the Updraft Tract. Preferably the wall is moved in a transverse direction to the Long Axis of the Tract. N.B. In all forms of the invention there may be provided Valve Means which are preferably Butterfly Valve Means to alter the flow rate of gas through a Tract of the Engine.

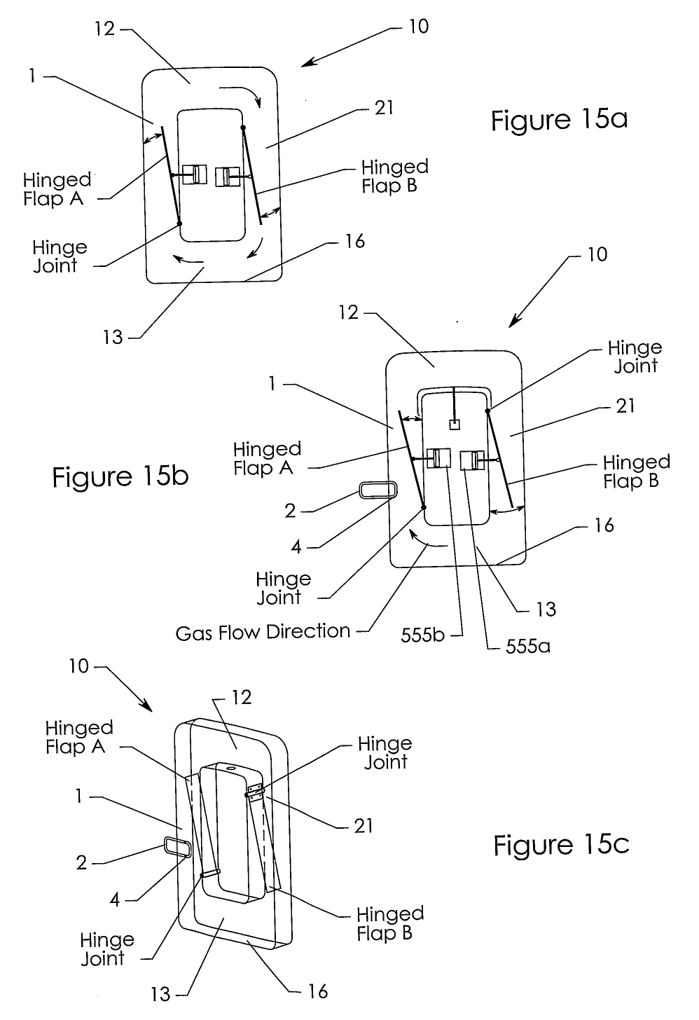

FIGS. 15a and 15b show a endless loop form of the invention which has side wall in its updraft tract and in its downdraft tract which can be swung on respective hinge means to alter the effective cross sectional area of said tracts relative to their respective long axis to change the gas flow rate within the engine. The engine including a updraft tract and a downdraft tract. the updraft tract and the downdraft tract being connected at their upper ends by an upper cross over tract portion 21 and the updraft tract and the downdraft tract being connected at their lower end by a lower crossover tract. The variable position side wall (flap A) of the updraft tract being swingable on hinge means and the tip if the flap being further away from the lower end of the updraft tract lower end than the hinge it swings on. The moveable side wall (flap B) in the down draft tract being swung in the same direction relative to gas flow as the flap in the updraft tract. The flaps A and B are the moveable side walls of the tracts and they may be adapted to be moved selectively by flap control and movement means which may be hydraulic actuated or be of any other useful means. FIGS. 15a and 15b a sectional schematic end views of a loop form of the engine wherein can be seen that the updraft tract 1 and the downdraft tract include hinged flaps which can be swung on their respective hinge on the hinge joint to alter the effective cross sectional of the respective tracts.

FIG. 15c is an isometric view of that shown in FIGS. 15a and 15c. The flaps are adapted to be swung on their hinges by motion means 555a and 555b as desired. NB. Hinge flap means or any other form of valve means may be included in all forms of the invention to alter the flow rate of gas in the engine.

There are a great many alterations which may be made to the embodiments contained herein but they are small changes in comparison the the invention and constituted shop improvements not able to diminish the scale and quality of the invention we have taught so go ahead and mix components from one embodiment to another as is intended throughout this document.

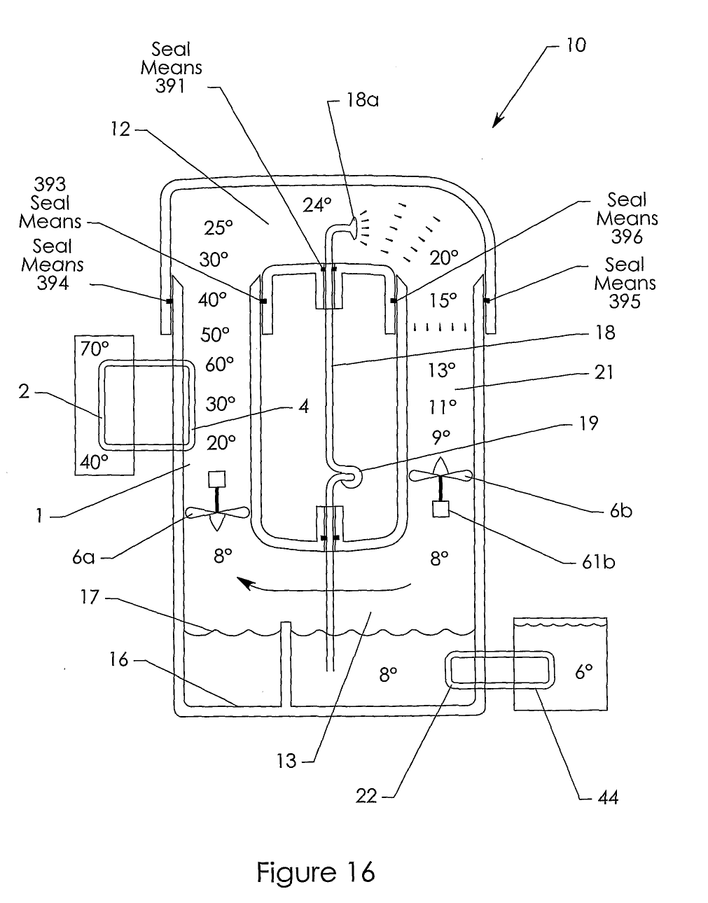

FIG. 16 Shows a sectional schematic end view of a loop form of the engine showing a scale which may be used at the temperature difference along the tracts during operation. NB this idealised but shows temperature differences. Variable Height Upper Crossover Head for adjusting gas flow through Engine

FIG. 17 a looped version of the engine

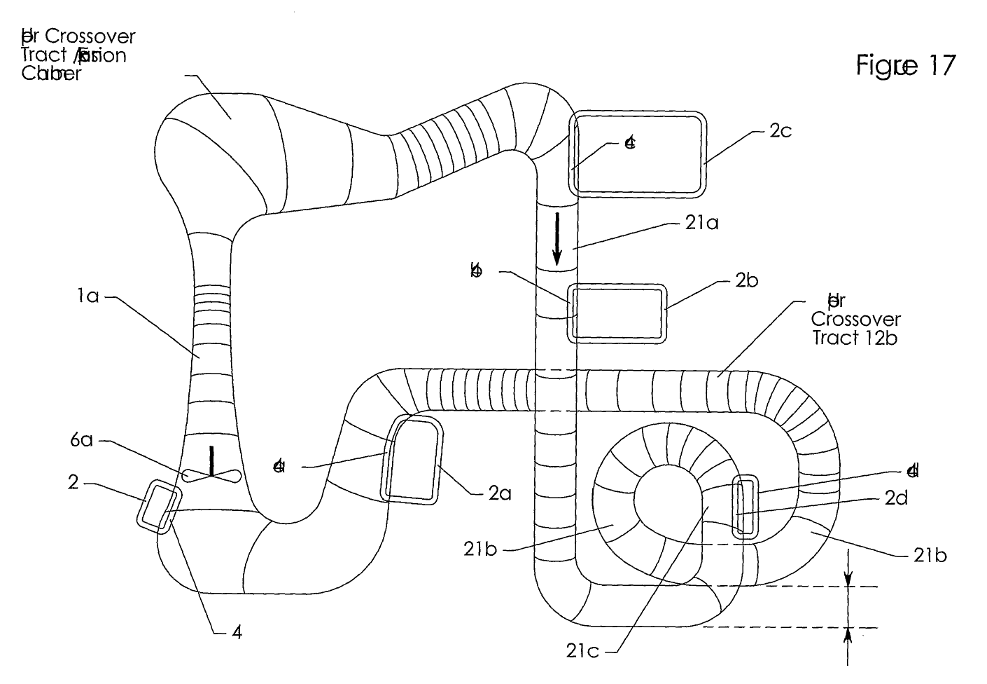

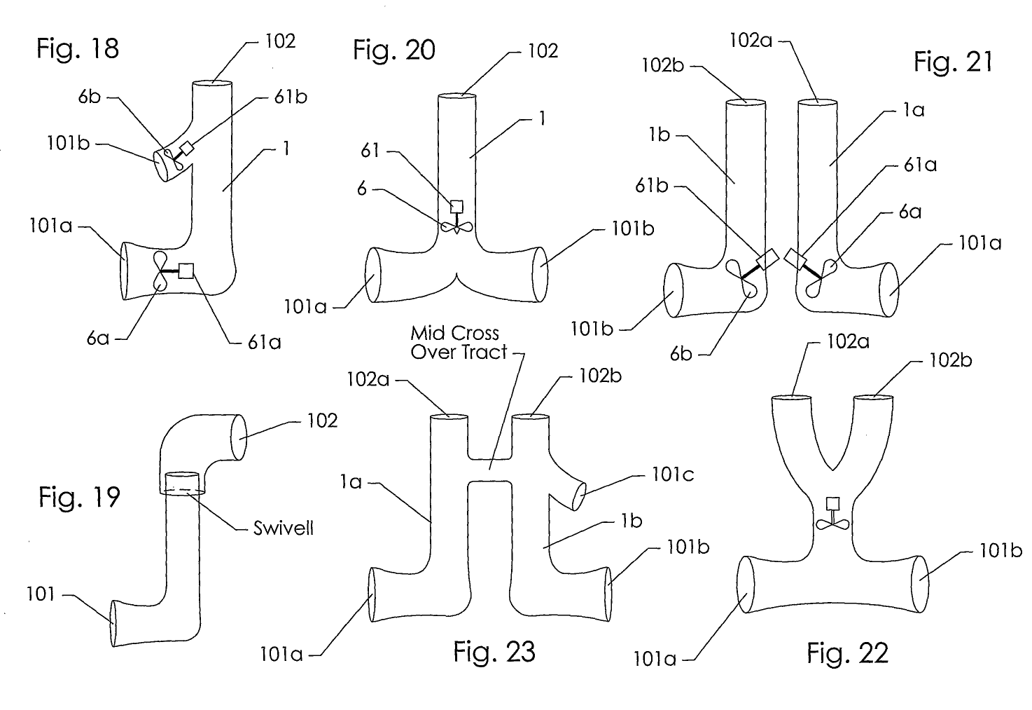

FIGS. 18 to 23 show views of various arrangements which can be adopted for updraft tract versions of the engine.

### STATEMENT OF UTILITY AND INDUSTRIAL APPLICABILITY

The invention has industrial applicability and utility because it obviates the need of a solar thermal engine to have a roof from under which the known engine must source hot air to drive the engine. The engine of the invention can be coupled to a suitable heat source being the suns rays or diffuse heat from the sun but can use heat from a variety of sources if required or in conjunction to that obtainable from the suns rays.

1. A thermal air engine including:
updraft tract means;
turbine means located within the updraft tract means such to extract work from air passing up the updraft tract means, the updraft tract having an upper end and a lower end;
collector means adapted to take up heat from a heat source and convey the taken up heat by fluid flow transportation to exchanger means located within the updraft tract whereupon the exchanger means exchanges heat into the air in the updraft tract causing the air to rise up the updraft tract.

2. A thermal air engine according to claim 1 including,
inlet orifice means located at the lower end of the updraft tract through which air may enter the updraft tract;
outlet orifice means at the upper end of the updraft tract through which can pass at least selectively air that has risen up the updraft tract.

3. A thermal air engine according to claim 1 including:
a downdraft tract having an upper end and a lower end and connected to the updraft tract by means of an upper crossover tract joining the upper end of the updraft tract and the upper end of the downdraft tract and wherein the downdraft tract includes at least one turbine means for the extraction of work from the air travelling down the downdraft tract into the atmosphere.

4. A thermal air engine according to claim 1 including:
a downdraft tract connected to the updraft tract by means of an upper crossover tract connecting the upper end of the updraft tract to the upper end of the downdraft tract and wherein the downdraft tract includes at least one turbine means for the extraction of work from the air travelling down the downdraft tract;
a lower crossover tract connecting the lower end of the downdraft tract to the lower end of the updraft tract together to form a endless loop air engine.

5. A thermal air engine according to claim 1 including:
a downdraft tract connected to the updraft tract by means of a upper crossover tract connecting the upper end of the updraft tract to the upper end of the downdraft tract and wherein the downdraft tract includes at least one turbine means for the extraction of work from the air travelling down the downdraft tract;
a lower crossover tract connecting the lower end of the downdraft tract to the lower end of the updraft tract together to form a endless loop air engine and wherein chill fluid introduction means is included in the upper crossover tract or upper end of the downdraft tract to assist in cooling the air in the upper crossover tract and/or upper end of the downdraft tract such that the air becomes denser and falls down the downdraft tract.

6. A thermal air engine according to claim 1 including:
a downdraft tract connected to the updraft tract by means of an upper crossover tract connecting the upper end of the updraft tract to the upper end of the downdraft tract and wherein the downdraft tract includes at least one turbine means for the extraction of work from the air travelling down the downdraft tract;
a lower crossover tract connecting the lower end of the downdraft tract to the lower end of the updraft tract together to form a endless loop air engine and wherein chill fluid introduction means is included in the upper crossover tract or upper end of the downdraft tract to assist in cooling the air in the upper crossover tract and/or upper end of the downdraft tract such that the air becomes denser and falls down the downdraft tract, and wherein cloud piston forming means is located above the turbine means in the updraft tract such that cloud pistons can be introduced into the updraft tract to rise up the updraft tract to create a partial vacuum between the underside of the cloud piston and the back of the turbine means pulling air through the turbine means of the updraft tract.

7. A thermal air engine according to claim 1 including:
a downdraft tract connected to the updraft tract by means of an upper crossover tract connecting the upper end of the updraft tract to the upper end of the downdraft tract and wherein the downdraft tract includes at least one turbine means for the extraction of work from the air travelling down the downdraft tract;
a lower crossover tract connecting the lower end of the downdraft tract to the lower end of the updraft tract together to form a endless loop air engine and wherein chill fluid introduction means is included in the upper crossover tract or upper end of the downdraft tract to assist in cooling the air in the upper crossover tract and/or upper end of the downdraft tract such that the air becomes denser and falls down the downdraft tract, and wherein cloud piston forming means is located above the turbine means in the updraft tract such that cloud pistons can be introduced into the updraft tract to rise up the updraft tract to create a partial vacuum between the underside of the cloud piston and the back of the turbine means pulling air through the turbine means of the updraft tract; and wherein the cloud pistons are charged with an electrical charge by a steam charging machine and the upper crossover tract includes discharge electrode means onto which the cloud piston discharges at least a portion of its electrical energy;
and wherein the upper cross over tract includes electrode means on which the cloud piston can discharge its charge.

8. A thermal air engine according to claim 1 including:
a downdraft tract connected to the updraft tract by means of an upper crossover tract connecting the upper end of the updraft tract to the upper end of the downdraft tract and wherein the downdraft tract includes at least one turbine means for the extraction of work from the air travelling down the downdraft tract;
a lower crossover tract connecting the lower end of the downdraft tract to the lower end of the updraft tract together to form a endless loop air engine and wherein chill fluid introduction means is included in the upper crossover tract or upper end of the downdraft tract to assist in cooling the air in the upper crossover tract and/or upper end of the downdraft tract such that the air becomes denser and falls down the downdraft tract, and wherein cloud piston forming means is located above the turbine means in the updraft tract such that cloud pistons can be introduced into the updraft tract to rise up the updraft tract to create a partial vacuum between the underside of the cloud piston and the back of the turbine means pulling air through the turbine means of the updraft tract;
and wherein the cloud pistons are charged with an electrical charge by a steam charging machine and the upper crossover tract includes discharge electrode means onto which the cloud piston discharges at least a portion of its electrical energy;
and wherein the upper crossover tract includes electrode means on which the cloud piston can discharge its charge.

9. The invention according to claim 1 wherein the heat source is the sun's rays or diffuse heat from the sun's rays.

10. The invention according to claim 2 wherein the heat source is the sun's rays or diffuse heat from the sun's rays.

11. The invention according to claim 3 wherein the heat source is the sun's rays or diffuse heat from the sun's rays.

12. The invention according to claim 4 wherein the heat source is the sun's rays or diffuse heat from the sun's rays.

13. The invention according to claim 5 wherein the heat source is the sun's rays or diffuse heat from the sun's rays.

14. The invention according to claim 6 wherein the heat source is the sun's rays or diffuse heat from the sun's rays.

15. The invention according to claim 7 wherein the heat source is the sun's rays or diffuse heat from the sun's rays.

16. The invention according to claim 8 wherein the heat source is the sun's rays or diffuse heat from the sun's rays.

17. The invention according to claim 1 wherein at least the updraft tract is tapered.

18. The invention according to claim 1 wherein at least the downdraft tract is tapered.

19. The invention according to claim 1 wherein the turbine means either directly or indirectly drives generator means is a hydraulic pressure pump generating pressurised oil for use by power machinery.

20. The invention according to claim 1 wherein the turbine means either directly or indirectly drives generating means is an electric current generating machine.

21.-85. (canceled)
